(19) United States
(12) Patent Application Publication
(10) Pub. No.: US 2026/0371439 A1
(43) Pub. Date: Nov. 19, 2026

(54) DYNAMIC CELL RADIO NETWORK TEMPORARY IDENTIFIER (C-RNTI) CHANGE FOR CUSTOMER PREMISES EQUIPMENT

(71) Applicant: QUALCOMM Incorporated, San Diego, CA (US)

(72) Inventors: Mostafa KHOSHNEVISAN, San Diego, CA (US); Navid ABEDINI, Basking Ridge, NJ (US); Jelena DAMNJANOVIC, Del Mar, CA (US); Tao LUO, San Diego, CA (US); Junyi LI, Greentown, PA (US); Sony AKKARAKARAN, Poway, CA (US)

(21) Appl. No.: 19/212,386

(22) Filed: May 19, 2025

(51) Int. Cl. H04W 76/28; H04W 8/22; H04W 74/0833; H04W 76/30

(52) U.S. Cl. CPC H04W 76/28; H04W 8/22; H04W 74/0833; H04W 76/30

(57) ABSTRACT

This disclosure provides methods, components, devices and systems for dynamic cell radio network temporary identifier (C-RNTI) change for customer premises equipment (CPE). For example, a user equipment (UE) may receive control signaling comprising an indication of a first radio network temporary identifier (RNTI) value, where receipt of the control signaling occurs while the UE is in a first radio resource control (RRC) connected state. The UE may transition to an idle state or an inactive state after receipt of the control signaling and may communicate with a network entity after being in the idle state or the inactive state, where communications with the network entity are based at least in part on the first RNTI value. The UE may further generate a set of RNTI values with a pseudo-random sequence, where the communications with the network entity are based at least in part on the set of RNTI values.

### TECHNICAL FIELD

This disclosure relates generally to wireless communication, and more specifically to systems, devices, methods, and techniques associated with dynamic cell radio network temporary identifier (C-RNTI) change for customer premises equipment (CPE).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving control signaling including an indication of a first radio network temporary identifier (RNTI) value, where receipt of the control signaling occurs while the UE is in a first RRC connected state, transitioning to an idle state or an inactive state after receipt of the control signaling, and communicating with a network entity after being in the idle state or the inactive state, where one or more communications with the network entity are based on the first RNTI value.

A UE for wireless communications is described. The UE may include a processing system that includes processor circuitry and memory circuitry that stores code. The processing system may be configured to cause the UE to receive control signaling including an indication of a first RNTI value, where receipt of the control signaling occurs while the UE is in a first RRC connected state, transition to an idle state or an inactive state after receipt of the control signaling, and communicate with a network entity after being in the idle state or the inactive state, where one or more communications with the network entity are based on the first RNTI value.

Another UE for wireless communications is described. The UE may include means for receiving control signaling including an indication of a first RNTI value, where receipt of the control signaling occurs while the UE is in a first RRC connected state, means for transitioning to an idle state or an inactive state after receipt of the control signaling, and means for communicating with a network entity after being in the idle state or the inactive state, where one or more communications with the network entity are based on the first RNTI value.

A non-transitory computer-readable medium storing code for wireless communications is described. The code may include instructions executable by one or more processors to receive control signaling including an indication of a first RNTI value, where receipt of the control signaling occurs while the UE is in a first RRC connected state, transition to an idle state or an inactive state after receipt of the control signaling, and communicate with a network entity after being in the idle state or the inactive state, where one or more communications with the network entity are based on the first RNTI value.

In some examples of the method, user equipment (UEs), and non-transitory computer-readable medium described herein, the control signaling includes a release message and the control signaling indicates that the UE may be to transition to the idle state or to the inactive state.

In some examples of the method, user equipment (UEs), and non-transitory computer-readable medium described herein, the control signaling may be further indicative of one or more timers which indicate a duration of time during which the UE may be permitted to use the first RNTI value and communicating with the network entity based on the first RNTI value after the UE may be in the idle state or the inactive state may be further based on satisfaction of the one or more timers.

Some examples of the method, user equipment (UEs), and non-transitory computer-readable medium described herein may further include operations, features, means, or instructions for communicating in accordance with the first RNTI value while the UE may be in the first RRC connected state, where the control signaling may be further indicative of a permission for the UE to communicate in accordance with the first RNTI value after the UE transitions from the first RRC connected state.

In some examples of the method, user equipment (UEs), and non-transitory computer-readable medium described herein, the control signaling may be further indicative of one or more cells for communication and communicating with the network entity based on the first RNTI value includes communicating with a cell of the one or more indicated cells for communication.

In some examples of the method, user equipment (UEs), and non-transitory computer-readable medium described herein, the control signaling may be received from a first cell associated with a first physical cell identifier and communicating with the network entity based on the first RNTI value may be based on the network entity being associated with the first physical cell identifier.

In some examples of the method, user equipment (UEs), and non-transitory computer-readable medium described herein, the control signaling may be further indicative of one or more resource sets associated with a random access procedure and the method, apparatuses, and non-transitory computer-readable medium may include further operations, features, means, or instructions for performing a first portion of the random access procedure in accordance with the one or more resource sets, the first portion of the random access procedure including a first message transmission and a second message reception, where the second message may be indicative that the UE may be to perform a second portion of the random access procedure, may be indicative of one or more additional RNTI values different from the first RNTI value, or both.

In some examples of the method, user equipment (UEs), and non-transitory computer-readable medium described herein, the first portion of the random access procedure corresponds to a contention-free random access procedure.

In some examples of the method, user equipment (UEs), and non-transitory computer-readable medium described herein, the first RNTI value may be one of a set of multiple RNTI values indicated by the control signaling and the second message indicates whether the UE may be to proceed or refrain from proceeding with the second portion of the random access procedure, that the UE may be to use the first RNTI value in the one or more communications with the network entity, or both.

A method for wireless communications by a UE is described. The method may include generating a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value, communicating in accordance with a first RNTI value of the first set of multiple RNTI values at a first instance of time based on the pseudo-random sequence generator, and communicating in accordance with one or more second RNTI values of the first set of multiple RNTI values at corresponding one or more second instances of time based on the pseudo-random sequence generator.

A UE for wireless communications is described. The UE may include a processing system that includes processor circuitry and memory circuitry that stores code. The processing system may be configured to cause the UE to generate a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value, communicate in accordance with a first RNTI value of the first set of multiple RNTI values at a first instance of time based on the pseudo-random sequence generator, and communicate in accordance with one or more second RNTI values of the first set of multiple RNTI values at corresponding one or more second instances of time based on the pseudo-random sequence generator.

Another UE for wireless communications is described. The UE may include means for generating a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value, means for communicating in accordance with a first RNTI value of the first set of multiple RNTI values at a first instance of time based on the pseudo-random sequence generator, and means for communicating in accordance with one or more second RNTI values of the first set of multiple RNTI values at corresponding one or more second instances of time based on the pseudo-random sequence generator.

A non-transitory computer-readable medium storing code for wireless communications is described. The code may include instructions executable by one or more processors to generate a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value, communicate in accordance with a first RNTI value of the first set of multiple RNTI values at a first instance of time based on the pseudo-random sequence generator, and communicate in accordance with one or more second RNTI values of the first set of multiple RNTI values at corresponding one or more second instances of time based on the pseudo-random sequence generator.

Some examples of the method, user equipment (UEs), and non-transitory computer-readable medium described herein may further include operations, features, means, or instructions for receiving initialization information that may be indicative of the first initialization seed value for the pseudo-random sequence generator.

In some examples of the method, user equipment (UEs), and non-transitory computer-readable medium described herein, individual ones of the first instance of time and the one or more second instances of time may be separated by a duration, the duration including a quantity of slots, a subframe, a radio frame, or any combination thereof.

Some examples of the method, user equipment (UEs), and non-transitory computer-readable medium described herein may further include operations, features, means, or instructions for receiving control signaling that indicates the duration.

Some examples of the method, user equipment (UEs), and non-transitory computer-readable medium described herein may further include operations, features, means, or instructions for resetting a current value of the first initialization seed value to an initial value of the first initialization seed value and generating one or more second pluralities of RNTI values based on an updated initial RNTI value and an additional pseudo-random sequence, where the pseudo-random sequence generator generates the one or more second pluralities of RNTI values based on the additional pseudo-random sequence in accordance with the function of time and the reset initial value of the first initialization seed value, and where each of the first initialization seed value and the reset initial value of the first initialization seed value may be applied at corresponding initialization times.

In some examples of the method, user equipment (UEs), and non-transitory computer-readable medium described herein, the corresponding initialization times may be each separated by a first duration, the first duration includes a quantity of radio frames, may be in accordance with a system frame number, or both, and the first duration may be greater than or equal to a second duration that separates individual ones of the first instance of time and the one or more second instances of time.

Some examples of the method, user equipment (UEs), and non-transitory computer-readable medium described herein may further include operations, features, means, or instructions for receiving control signaling indicating the first duration, the second duration, or both.

Some examples of the method, user equipment (UEs), and non-transitory computer-readable medium described herein may further include operations, features, means, or instructions for transmitting capability information indicating an ability of the UE to operate in accordance with the first set of multiple RNTI values based on the pseudo-random sequence generator and receiving control signaling including an indication to operate in accordance with the first set of multiple RNTI values based on the pseudo-random sequence generator, where the control signaling may be based on the capability information.

Some examples of the method, user equipment (UEs), and non-transitory computer-readable medium described herein may further include operations, features, means, or instructions for receiving control signaling indicating a first set of allowable RNTI values permitted for communication, where the first set of multiple RNTI values may be in accordance with the first set of allowable RNTI values, where the first set of allowable RNTI values may be associated with the UE and may be different from a second set of allowable RNTI values associated with one or more additional UEs.

Some examples of the method, user equipment (UEs), and non-transitory computer-readable medium described herein may further include operations, features, means, or instructions for receiving control signaling that indicates a type of the first set of multiple RNTI values for which the pseudo-random sequence generator may be used, where the type may be one of a cell RNTI (C-RNTI), a configured scheduling RNTI (CS-RNTI), a modulation and coding scheme C-RNTI (MCS-C-RNTI), a slot format indication RNTI (SFI-RNTI), a transmit power control for physical uplink shared channel RNTI (TPC PUSCH-RNTI), a transmit power control for physical uplink control channel RNTI (TPC PUCCH-RNTI), or a transmit power control sounding reference signal RNTI (TPC SRS-RNTI).

A method for wireless communications by a UE is described. The method may include receiving signaling that includes an indication of a first RNTI value, where receipt of the signaling occurs while the UE is in an RRC idle state or an RRC inactive state, and where the signaling includes a paging message, transitioning to an active state after receipt of the signaling, and communicating with a network entity after transitioning to the active state, where one or more communications with the network entity are based on the first RNTI.

A UE for wireless communications is described. The UE may include a processing system that includes processor circuitry and memory circuitry that stores code. The processing system may be configured to cause the UE to receive signaling that includes an indication of a first RNTI value, where receipt of the signaling occurs while the UE is in an RRC idle state or an RRC inactive state, and where the signaling includes a paging message, transition to an active state after receipt of the signaling, and communicate with a network entity after transitioning to the active state, where one or more communications with the network entity are based on the first RNTI.

Another UE for wireless communications is described. The UE may include means for receiving signaling that includes an indication of a first RNTI value, where receipt of the signaling occurs while the UE is in an RRC idle state or an RRC inactive state, and where the signaling includes a paging message, means for transitioning to an active state after receipt of the signaling, and means for communicating with a network entity after transitioning to the active state, where one or more communications with the network entity are based on the first RNTI.

A non-transitory computer-readable medium storing code for wireless communications is described. The code may include instructions executable by one or more processors to receive signaling that includes an indication of a first RNTI value, where receipt of the signaling occurs while the UE is in an RRC idle state or an RRC inactive state, and where the signaling includes a paging message, transition to an active state after receipt of the signaling, and communicate with a network entity after transitioning to the active state, where one or more communications with the network entity are based on the first RNTI.

Some examples of the method, user equipment (UEs), and non-transitory computer-readable medium described herein may further include operations, features, means, or instructions for receiving timing information that indicates a time for the UE to apply the first RNTI value, where communicating with the network entity using the first RNTI value may be in accordance with the indicated time.

In some examples of the method, user equipment (UEs), and non-transitory computer-readable medium described herein, the indicated time to apply the first RNTI value may be with respect to a timing of the transition to the active state or a timing of transmission of associated feedback that corresponds with the signaling and the indicated time may be indicated in terms of a quantity of symbols, a quantity of slots, a quantity of time, or any combination thereof.

Some examples of the method, user equipment (UEs), and non-transitory computer-readable medium described herein may further include operations, features, means, or instructions for receiving, via the signaling, an indication of one or more component carriers associated with the first RNTI value, where communicating in accordance with the first RNTI value may be based on communicating via a component carrier of the one or more indicated component carriers.

A method for wireless communications by a network entity is described. The method may include transmitting control signaling including an indication of a first RNTI value, where receipt of the control signaling occurs while a UE is in a first RRC connected state and communicating with a UE after the UE operates in an idle state or an inactive state, where one or more communications with the UE are based on the first RNTI value.

A network entity for wireless communications is described. The network entity may include a processing system that includes processor circuitry and memory circuitry that stores code. The processing system may be configured to cause the network entity to transmit control signaling including an indication of a first RNTI value, where receipt of the control signaling occurs while a UE is in a first RRC connected state and communicate with a UE after the UE operates in an idle state or an inactive state, where one or more communications with the UE are based on the first RNTI value.

Another network entity for wireless communications is described. The network entity may include means for transmitting control signaling including an indication of a first RNTI value, where receipt of the control signaling occurs while a UE is in a first RRC connected state and means for communicating with a UE after the UE operates in an idle state or an inactive state, where one or more communications with the UE are based on the first RNTI value.

A non-transitory computer-readable medium storing code for wireless communications is described. The code may include instructions executable by one or more processors to transmit control signaling including an indication of a first RNTI value, where receipt of the control signaling occurs while a UE is in a first RRC connected state and communicate with a UE after the UE operates in an idle state or an inactive state, where one or more communications with the UE are based on the first RNTI value.

In some examples of the method, network entities, and non-transitory computer-readable medium described herein, the control signaling includes a release message and the control signaling indicates that the UE may be to transition to the idle state or to the inactive state.

In some examples of the method, network entities, and non-transitory computer-readable medium described herein, the control signaling may be further indicative of one or more timers which indicate a duration of time during which the UE may be permitted to use the first RNTI value and communicating with the UE based on the first RNTI value after the UE may be in the idle state or the inactive state may be further based on satisfaction of the one or more timers.

Some examples of the method, network entities, and non-transitory computer-readable medium described herein may further include operations, features, means, or instructions for communicating in accordance with the first RNTI value while the UE may be in the first RRC connected state, where the control signaling may be further indicative of a permission for the UE to communicate in accordance with the first RNTI value after the UE transitions from the first RRC connected state.

In some examples of the method, network entities, and non-transitory computer-readable medium described herein, the control signaling may be further indicative of one or more resource sets associated with a random access procedure and the method, apparatuses, and non-transitory computer-readable medium may include further operations, features, means, or instructions for performing a first portion of the random access procedure in accordance with the one or more resource sets, the first portion of the random access procedure including a first message reception and a second message transmission, where the second message may be indicative that the UE may be to perform a second portion of the random access procedure, may be indicative of one or more additional RNTI values different from the first RNTI value, or both.

In some examples of the method, network entities, and non-transitory computer-readable medium described herein, the first portion of the random access procedure corresponds to a contention-free random access procedure.

In some examples of the method, network entities, and non-transitory computer-readable medium described herein, the first RNTI value may be one of a set of multiple RNTI values indicated by the control signaling and the second message indicates whether the UE may be to proceed or refrain from proceeding with the second portion of the random access procedure, that the UE may be to use the first RNTI value in the one or more communications with the UE, or both.

A method for wireless communications by a network entity is described. The method may include communicating in accordance with a first RNTI value of a first set of multiple RNTI values at a first instance of time, where a pseudo-random sequence generator generates the first set of multiple RNTI values in accordance with a pseudo-random sequence as a function of time and a first initialization seed value and communicating with a UE in accordance with one or more second RNTI values of the first set of multiple RNTI values at corresponding one or more second instances of time based on the pseudo-random sequence generator.

A network entity for wireless communications is described. The network entity may include a processing system that includes processor circuitry and memory circuitry that stores code. The processing system may be configured to cause the network entity to communicate in accordance with a first RNTI value of a first set of multiple RNTI values at a first instance of time, where a pseudo-random sequence generator generates the first set of multiple RNTI values in accordance with a pseudo-random sequence as a function of time and a first initialization seed value and communicate with a UE in accordance with one or more second RNTI values of the first set of multiple RNTI values at corresponding one or more second instances of time based on the pseudo-random sequence generator.

Another network entity for wireless communications is described. The network entity may include means for communicating in accordance with a first RNTI value of a first set of multiple RNTI values at a first instance of time, where a pseudo-random sequence generator generates the first set of multiple RNTI values in accordance with a pseudo-random sequence as a function of time and a first initialization seed value and means for communicating with a UE in accordance with one or more second RNTI values of the first set of multiple RNTI values at corresponding one or more second instances of time based on the pseudo-random sequence generator.

A non-transitory computer-readable medium storing code for wireless communications is described. The code may include instructions executable by one or more processors to communicate in accordance with a first RNTI value of a first set of multiple RNTI values at a first instance of time, where a pseudo-random sequence generator generates the first set of multiple RNTI values in accordance with a pseudo-random sequence as a function of time and a first initialization seed value and communicate with a UE in accordance with one or more second RNTI values of the first set of multiple RNTI values at corresponding one or more second instances of time based on the pseudo-random sequence generator.

Some examples of the method, network entities, and non-transitory computer-readable medium described herein may further include operations, features, means, or instructions for transmitting initialization information that may be indicative of the first initialization seed value for the pseudo-random sequence generator.

In some examples of the method, network entities, and non-transitory computer-readable medium described herein, individual ones of the first instance of time and the one or more second instances of time may be separated by a duration, the duration including a quantity of slots, a subframe, a radio frame, or any combination thereof.

Some examples of the method, network entities, and non-transitory computer-readable medium described herein may further include operations, features, means, or instructions for transmitting control signaling that indicates the duration.

Some examples of the method, network entities, and non-transitory computer-readable medium described herein may further include operations, features, means, or instructions for receiving capability information indicating an ability of the UE to operate in accordance with the first set of multiple RNTI values based on the pseudo-random sequence generator and transmitting control signaling including an indication to operate in accordance with the first set of multiple RNTI values based on the pseudo-random sequence generator, where the control signaling may be based on the capability information.

Some examples of the method, network entities, and non-transitory computer-readable medium described herein may further include operations, features, means, or instructions for transmitting control signaling indicating a first set of allowable RNTI values permitted for communication, where the first set of multiple RNTI values may be in accordance with the first set of allowable RNTI values, where the first set of allowable RNTI values may be associated with the UE and may be different from a second set of allowable RNTI values associated with one or more additional UEs.

Some examples of the method, network entities, and non-transitory computer-readable medium described herein may further include operations, features, means, or instructions for transmitting control signaling that indicates a type of the first set of multiple RNTI values for which the pseudo-random sequence generator may be used, where the type may be one of a cell RNTI (C-RNTI), a configured scheduling RNTI (CS-RNTI), a modulation and coding scheme C-RNTI (MCS-C-RNTI), a slot format indication RNTI (SFI-RNTI), a transmit power control for physical uplink shared channel RNTI (TPC PUSCH-RNTI), a transmit power control for physical uplink control channel RNTI (TPC PUCCH-RNTI), or a transmit power control sounding reference signal RNTI (TPC SRS-RNTI).

A method for wireless communications by a network entity is described. The method may include transmitting signaling that includes an indication of a first RNTI value, where receipt of the signaling occurs while a UE is in an RRC idle state or an RRC inactive state, and where the signaling includes a paging message and communicating with the UE after the UE transitions to an active state after receipt of the signaling and after subsequently transitioning to the active state, where one or more communications with the UE are based on the first RNTI.

A network entity for wireless communications is described. The network entity may include a processing system that includes processor circuitry and memory circuitry that stores code. The processing system may be configured to cause the network entity to transmit signaling that includes an indication of a first RNTI value, where receipt of the signaling occurs while a UE is in an RRC idle state or an RRC inactive state, and where the signaling includes a paging message and communicate with the UE after the UE transitions to an active state after receipt of the signaling and after subsequently transitioning to the active state, where one or more communications with the UE are based on the first RNTI.

Another network entity for wireless communications is described. The network entity may include means for transmitting signaling that includes an indication of a first RNTI value, where receipt of the signaling occurs while a UE is in an RRC idle state or an RRC inactive state, and where the signaling includes a paging message and means for communicating with the UE after the UE transitions to an active state after receipt of the signaling and after subsequently transitioning to the active state, where one or more communications with the UE are based on the first RNTI.

A non-transitory computer-readable medium storing code for wireless communications is described. The code may include instructions executable by one or more processors to transmit signaling that includes an indication of a first RNTI value, where receipt of the signaling occurs while a UE is in an RRC idle state or an RRC inactive state, and where the signaling includes a paging message and communicate with the UE after the UE transitions to an active state after receipt of the signaling and after subsequently transitioning to the active state, where one or more communications with the UE are based on the first RNTI.

Some examples of the method, network entities, and non-transitory computer-readable medium described herein may further include operations, features, means, or instructions for transmitting timing information that indicates a time for the UE to apply the first RNTI value, where communicating with the UE using the first RNTI value may be in accordance with the indicated time.

In some examples of the method, network entities, and non-transitory computer-readable medium described herein, the indicated time to apply the first RNTI value may be with respect to a timing of the transition to the active state or a timing of transmission of associated feedback that corresponds with the signaling and the indicated time may be indicated in terms of a quantity of symbols, a quantity of slots, a quantity of time, or any combination thereof.

Some examples of the method, network entities, and non-transitory computer-readable medium described herein may further include operations, features, means, or instructions for transmitting, via the signaling, an indication of one or more component carriers associated with the first RNTI value, where communicating in accordance with the first RNTI value may be based on communicating via a component carrier of the one or more indicated component carriers.

### BRIEF DESCRIPTION OF THE DRAWINGS

FIG. 1 shows an example of a wireless communication system.

FIG. 2 shows an example of a signaling diagram that supports dynamic cell radio network temporary identifier (C-RNTI) change for customer premises equipment (CPE).

FIG. 3 shows an example of a communication timeline that supports dynamic C-RNTI change for CPE.

FIG. 4 shows an example of a process flow that supports dynamic C-RNTI change for CPE.

FIG. 5 shows an example of a process flow that supports dynamic C-RNTI change for CPE.

FIG. 6 shows a block diagram of a processing system that supports dynamic C-RNTI change for CPE.

FIG. 7 shows a diagram of a system including a device that supports dynamic C-RNTI change for CPE.

FIG. 8 shows a block diagram of a processing system that supports dynamic C-RNTI change for CPE.

FIG. 9 shows a diagram of a system including a device that supports dynamic C-RNTI change for CPE.

FIGS. 10 through 13 show flowcharts illustrating methods that support dynamic C-RNTI change for CPE.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may perform communications with a user equipment (UE), which may be a consumer premises equipment (CPE) device (e.g., a stationary device). In some cases, the UE may perform an initial access procedure (e.g., a random access channel (RACH) procedure) to obtain a cell radio network temporary identifier (C-RNTI) value for communication with the network entity. For example, the UE may transmit a first message of the initial access procedure and may receive a second message of the initial access procedure including the C-RNTI value. The UE may perform a remainder of the initial access procedure and may communicate in accordance with the C-RNTI value based on a successful completion of the initial access procedure. In some cases, the UE may perform the initial access procedure based on transitioning to an idle state (e.g., idle or inactive state). In some cases, the UE may communicate with a pervious C-RNTI value (e.g., a C-RNTI value used by the UE before transitioning to the idle state) after transitioning back to a connected state (e.g., after operating in the idle state).

In some cases, the UE may communicate using the previous C-RNTI value based on the UE being stationary, among other examples, which may result in relatively unchanging (e.g., stable) channel conditions). Accordingly, in such cases, performing the initial access procedure each time the UE transitions to the idle state may be inefficient, and may increase a signaling overhead unnecessarily. Additionally, or alternatively, communicating according to the previous C-RNTI value (e.g., without an update to the C-RNTI value) may result in collisions between one or more UE based on the devices using a same C-RNTI value, or an eavesdropping device may determine the C-RNTI value (e.g., by observing communications between the UE and the network entity over time). In some cases, updating the C-RNTI value via radio resource control (RRC) signaling, may incur a relatively large signaling overhead (e.g., compared to lower-layer signaling).

Aspects of the subject matter described in this disclosure relate to dynamic C-RNTI change for CPE. For example, a network entity may transmit signaling (e.g., lower-layer signaling) to the UE including an indication of an updated C-RNTI value. For example, the network entity may transmit downlink control information (DCI) or medium access control control element (MAC-CE) signaling indicating the updated C-RNTI value during a connected state (e.g., RRC connected state). Additionally, or alternatively, the network entity may transmit a paging message indicating the updated C-RNTI value during an idle (e.g., idle or inactive) state. In some examples, the network entity may indicate, via the signaling, a time to apply the updated C-RNTI value. In some examples, the network entity may indicate (e.g., via the lower-layer signaling, or via RRC signaling) one or more timing parameters associated with an application of the updated C-RNTI value. By indicating the C-RNTI value via lower-layer signaling, by indicating a time the UE may apply the C-RNTI value, or both, the UE may refrain from performing an initial access procedure (e.g., an entire RACH procedure), which may reduce signaling overhead.

In some implementations, the UE may perform a C-RNTI hopping procedure. In some examples, the UE may generate a set of C-RNTI values based on an initialization identifier (ID) value (e.g., a seed value) using a pseudo-random sequence. In such examples, the UE may apply a different C-RNTI value of the set of C-RNTI values at one or more time intervals, and the UE may reset the initialization ID value at one or more different time intervals. The network entity may indicate a set (e.g., a subspace, or a subset) of C-RNTI values that the UE may apply, and the generated set of C-RNTI values may be included in the indicated set of C-RNTI values. By generating the set of C-RNTI values using the pseudo-random sequence, the UE may refrain from performing an initial access procedure (e.g., an entire RACH procedure), which may reduce signaling overhead.

Particular aspects of the subject matter described in this disclosure can be implemented to realize one or more of the following potential advantages. In some examples, by indicating the updated C-RNTI value via lower-layer signaling, or via paging messages, by indicating timing parameters to associated with future application of the updated C-RNTI values, or by performing the C-RNTI hopping, the described techniques can be used to reduce signaling overhead associated with performing RACH procedures to obtain the updated C-RNTI values, or to improve an efficiency associated with indicating the updated C-RNTI values (e.g., compared to RRC reconfiguration) among other improvements.

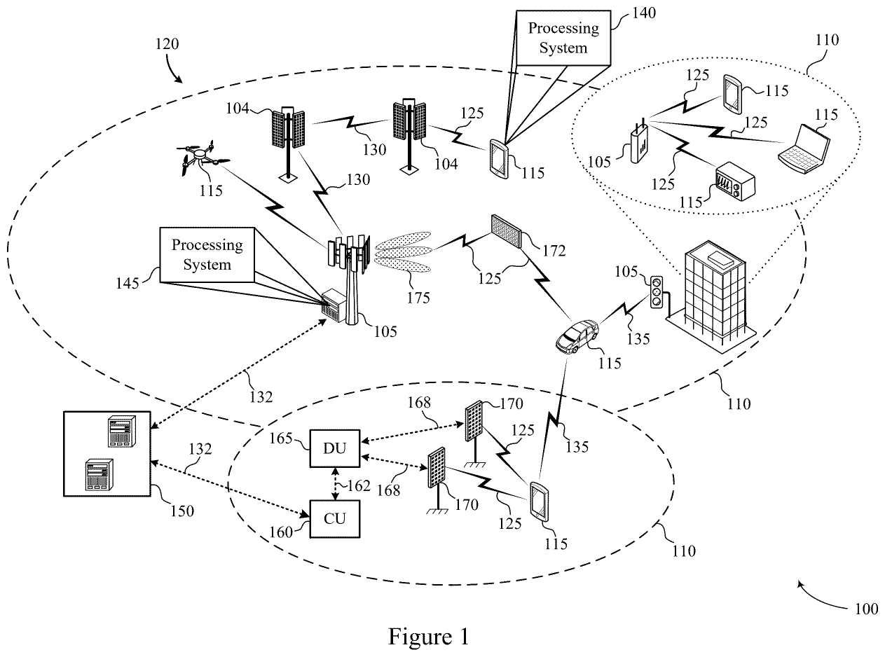

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Other techniques for reducing power consumption at UEs 115 may include a low-power wake up radio (LP-WUR). The LP-WUR may receive one or more signals while a UE 115 is in a sleep mode. For example, the LP-WUR may receive low-power wakeup signal (LP-WUS) or low-power synchronization signal (LP-SS) transmissions. The LP-WUS transmissions may indicate for the UE 115 to transition to an awake state and power on a main radio to perform wireless communications with another device (e.g., with the network entity 105). The LP-SS transmissions may be used by the LP-WUR for time and frequency synchronizations or channel measurements for the UE 115.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

Devices of the wireless communication system 100 may be configured to support one or more aspects of the described techniques for dynamic C-RNTI change for CPE. For example, a UE 115 115 may include a processing system 140, and a network entity 105 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support dynamic C-RNTI for CPE. For example, a network entity 105 may transmit signaling (e.g., lower-layer signaling) to the UE 115 including an indication of an updated C-RNTI value. For example, the network entity 105 may transmit DCI or MAC-CE signaling indicating the updated C-RNTI value during a connected state (e.g., RRC connected state). Additionally, or alternatively, the network entity 105 may transmit a paging message indicating the updated C-RNTI value during an idle (e.g., idle or inactive) state. In some examples, the network entity 105 may indicate, via the signaling, a time to apply the updated C-RNTI value. In some examples, the network entity 105 may indicate (e.g., via the lower-layer signaling, or via RRC signaling) one or more timing parameters associated with an application of the updated C-RNTI value. By indicating the C-RNTI value via lower-layer signaling, by indicating a time the UE 115 may apply the C-RNTI value, or both, the UE 115 may refrain from performing an initial access procedure (e.g., an entire RACH procedure), which may reduce signaling overhead.

In some implementations, the UE 115 may perform a C-RNTI hopping procedure. In some examples, the UE 115 may generate a set of C-RNTI values based on an initialization identifier (ID) value (e.g., a seed value) using a pseudo-random sequence. In such examples, the UE 115 may apply a different C-RNTI value of the set of C-RNTI values at one or more time intervals, and the UE 115 may reset the initialization ID value at one or more different time intervals. The network entity 105 may indicate a set (e.g., a subspace, or a subset) of C-RNTI values that the UE 115 may apply, and the generated set of C-RNTI values may be included in the indicated set of C-RNTI values. By generating the set of C-RNTI values using the pseudo-random sequence, the UE 115 may refrain from performing an initial access procedure (e.g., an entire RACH procedure), which may reduce signaling overhead.

Particular aspects of the subject matter described in this disclosure can be implemented to realize one or more of the following potential advantages. In some examples, by indicating the updated C-RNTI value via lower-layer signaling, or via paging messages, by indicating timing parameters to associated with future application of the updated C-RNTI values, or by performing the C-RNTI hopping, the described techniques can be used to reduce signaling overhead associated with performing RACH procedures to obtain the updated C-RNTI values, or to improve an efficiency associated with indicating the updated C-RNTI values (e.g., compared to RRC reconfiguration) among other improvements.

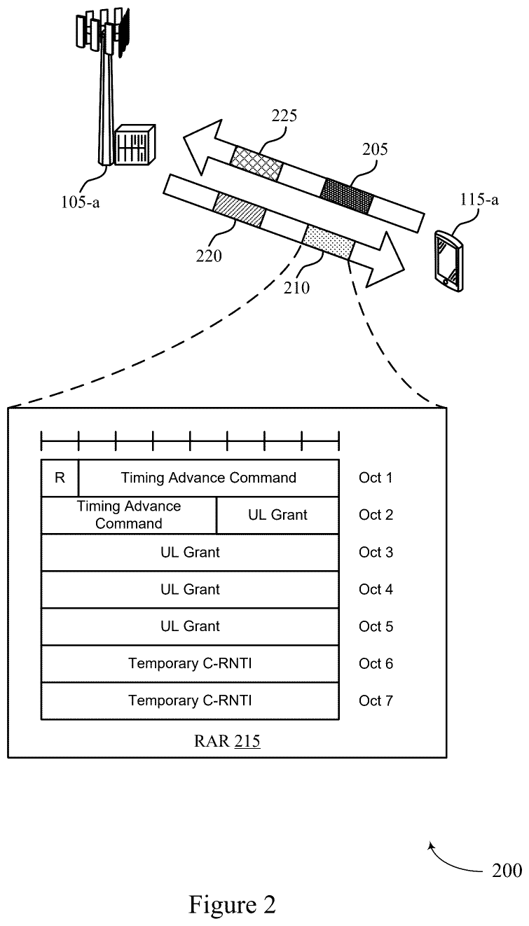

FIG. 2 shows an example of a signaling diagram 200 that supports dynamic C-RNTI change for CPE. Aspects of the signaling diagram 200 may implement or be implemented by aspects of the wireless communication system 100. For example, the signaling diagram 200 may include a UE 115-a and a network entity 105-a, which may be examples of the UE 115 and the network entity 105 respectively.

In some cases, the network entity 105-a may communicate with the UE 115-a, which may be a CPE device (e.g., or a fixed wireless access (FWA) device), among other examples. In some cases, the UE 115-a may be stationary and may operate according to relatively stable channel conditions (e.g., based on the UE 115-a being a CPE device). Additionally, or alternatively, the UE 115-a may be capable of supporting higher transmission power communications (e.g., high transmission power and/or effective isotropic radiated power (EIRP)) compared to one or more non-CPE devices.

In some cases, the UE 115-a may perform one or more access procedures (e.g., initial access procedures, or RACH procedures). For example, the UE 115-a may perform the access procedures based on connecting to a cell, or based on transitioning to a connected state (e.g., an RRC connected state) from an idle state (e.g., an idle state, or an inactive state). In some cases, many CPEs may be deployed (e.g., the network entity 105-a may communicate with multiple CPEs) and, due to aggregated traffic associated with the CPEs, a cell may be heavily loaded at times (e.g., during the afternoon hours, when people are at home). In such cases, the network entity may benefit from performing reduced (e.g., simplified) access procedures with the UE 115-a (e.g., the CPE devices). For example, reducing signaling or time (e.g., latency) for each reconnection may reduce the associated overhead for the network entity 105-a. Additionally, or alternatively, speeding up the connection (e.g., based on the characteristics of CPEs such as high-power and stationary operation), may improve communication key performance indicators (KPIs), or the like. For example, the UE 115-a may refrain from performing full initial access procedures each time the UE 115-a enters the idle/inactive state (e.g., acquiring one or more timing advances (TAs) may be unnecessary).

In some cases, the UE 115-a may obtain C-RNTI value as part of the initial access procedures (e.g., for a UE in idle/inactive state). The UE 115-a may transmit a first message 205 of a RACH procedure (e.g., UE 115-a sends RACH), and the UE 115-a may receive a second message 210 (MSG2) of the RACH procedure in response to the first message 205. For example, the UE 115-a may receive, via the second message 210, a random access response (RAR) 215 including a temporary C-RNTI (TC-RNTI) value. The UE 115-a may perform a remainder of the RACH procedure, and the UE 115-a may set a C-RNTI value to the indicated TC-RNTI value based on a successful contention resolution (MSG4) of the RACH procedure. Additionally, or alternatively, the network entity 105-a may transmit control signaling (e.g., RRC signaling) updating the C-RNTI value during a connected mode of the UE 115-a (e.g., via RRC reconfiguration during a RRC connected mode).

In some cases, the UE 115-a (e.g., stationary UEs (CPEs)) may operate in a semi-disconnected mode with some configured or stored RRC information (e.g., for faster reconnection), and the UE 115-a may utilize the stored RRC information to reconnect without performing full initial access procedures. In such cases, the UE 115-a may communicate using a stored C-RNTI value (e.g., included in the stored RRC information) after reconnecting, which may result in collisions (e.g., between one or more CPEs or other UEs), the network entity 105-a may be unable to reuse the stored C-RNTI value for other UEs different from the UE 115-a, or both. Additionally, or alternatively, in cases where the UE 115-a applies the sored C-RNTI value, a nearby eavesdropper device may determine (e.g., detect, or decipher) the stored C-RNTI over time, which may present a security concern. The eavesdropper may determine the stored C-RNTI based on the UE 115-a being stationary (e.g., which may be more difficult for mobile UEs).

The techniques, methods, and devices described herein may support dynamic C-RNTI for CPE. For example, the UE 115-a may perform a more efficient (e.g., faster) procedure to update C-RNTI (e.g., compared to RRC reconfiguration of the C-RNTI value). Additionally, or alternatively, the network entity 105-a may provide (e.g., transmit an indication of) information/conditions related to an updated C-RNTI value while the UE 115-a operates in the connected mode (e.g., before transitioning to idle/inactive mode) such that the UE 115-a may use the updated C-RNTI value during a next reconnection. In some examples, the UE 115-a may perform randomization of C-RNTI over time (e.g., ensuring no collisions across different UEs).

In some implementations, the network entity 105-a may transmit signaling 220 indicating an updated C-RNTI value, which may include lower-layer signaling (e.g., MAC-CE or DCI) during connected modes or paging messages in idle/inactive modes. In some examples, the network entity 105-a may indicate the updated C-RNTI value (e.g., the update may be applicable) for communication with one or more primary component carriers (CCs) associated with a primary cell (PCell), one or more secondary cells (SCells), or both. In such examples, the UE 115-a may apply the updated C-RNTI value for each CC associated with the UE 115-a, one or more indicated CCs, or a group of CCs (e.g., a group of indicated CCs).

In some implementations, the UE 115-a may operate during a connected mode (e.g., RRC connected). Accordingly, the UE 115-a may apply the updated C-RNTI at a time (e.g., a given time). For example, the UE 115-a may transmit feedback (e.g., hybrid automated repeat request (HARQ) acknowledgement (ACK)) associated with the signaling 220, and the UE 115-a may apply the updated C-RNTI a duration of time, a quantity of slots or symbols, or both after transmitting the feedback. The UE 115-a may apply the updated C-RNTI value after a duration of time (e.g., 3 milliseconds (ms)) based on receiving MAC-CE, or the UE 115-a may apply the updated C-RNTI value a quantity of slots or symbols (e.g., X slots/symbols) based on receiving DCI. In some cases, the quantity of slots or symbols (e.g., X) may be fixed, configured, or based on a capability of the UE 115-a. Accordingly, the UE 115-a may monitor for DCI (e.g., UE-specific DCI formats) transmitted according to the updated C-RNTI based on applying the update.

In some implementations, the UE 115-a may operate according to the idle mode. In such implementations, the UE 115-a may apply the updated C-RNTI during a subsequent reconnection (e.g., the next time the UE tries to connect). For example, the UE 115-a may receive the signaling 220 via a paging message during an idle (e.g., idle or inactive) mode of the UE 115-a, and the UE 115-a may apply the updated C-RNTI based on transitioning from the idle mode to the connected mode (e.g., the RRC connected mode), or the UE 115-a may apply the updated C-RNTI for monitoring control and data (e.g., short messages) while the UE 115-a operates in the idle or inactive mode. For example, the UE 115-a may apply the updated C-RNTI when attempting to connect (e.g., but may not be in connected state yet). Additionally, or alternatively, the UE 115-a may apply the updated C-RNTI according to a delay (e.g., a duration of time or a quantity of slots or symbols) after transitioning to the connected mode.

In some implementations, the network entity 105-a may transmit the signaling 220 including a field to indicate the updated C-RNTI value, a field to indicate a CC index or CC group index (e.g., in connected mode), a field to indicate whether the updated C-RNTI may be applicable to each CC or a subset of CCs (e.g., in connected mode), a field to indicate the time to apply the updated C-RNTI (e.g., the value of X if X is also based on lower-layer signaling, if X is not RRC-configured or fixed), or any combination thereof. In some cases, the indication of the CC index of CC group index may be included in a carrier indicator field (CIF) based on receiving the signaling 220 via DCI.

In some examples, the network entity 105-a may transmit the signaling 220 via a downlink DCI format (e.g., DCI format 1_0, 1_1, 1_2, or a different DCI format), and the network entity 105-a may transmit (e.g., or may refrain from transmitting) a PDSCH message associated with the DCI format. In such examples, the network entity 105-a may schedule, via the DCI message, associated HARQ-ACK feedback or a different uplink signal for confirmation of the updated C-RNTI. The network entity 105-a may scramble a cyclic redundancy check (CRC) of the DCI with a previous C-RNTI value (e.g., the updated C-RNTI is not applied yet) or a dedicated RNTI different from the updated C-RNTI.

In some implementations, the UE 115-a may apply the updated C-RNTI value, and the UE 115-a may communicate one or more messages 225 in accordance with the updated C-RNTI value. For example, the UE 115-a may transmit one or more uplink messages in accordance with the updated C-RNTI, or the UE 115-a may monitor for one or more DCI messages based on the C-RNTI (e.g., DCI messages with CRCs scrambled with the updated C-RNTI), among other examples.

Particular aspects of the subject matter described in this disclosure can be implemented to realize one or more of the following potential advantages. In some examples, by indicating the updated C-RNTI value via lower-layer signaling, or via paging messages, by indicating timing parameters to associated with future application of the updated C-RNTI values, or both, the described techniques can be used to reduce signaling overhead associated with performing RACH procedures to obtain the updated (e.g., new)C-RNTI values, or to improve an efficiency associated with indicating the updated C-RNTI values (e.g., compared to RRC reconfiguration) among other improvements.

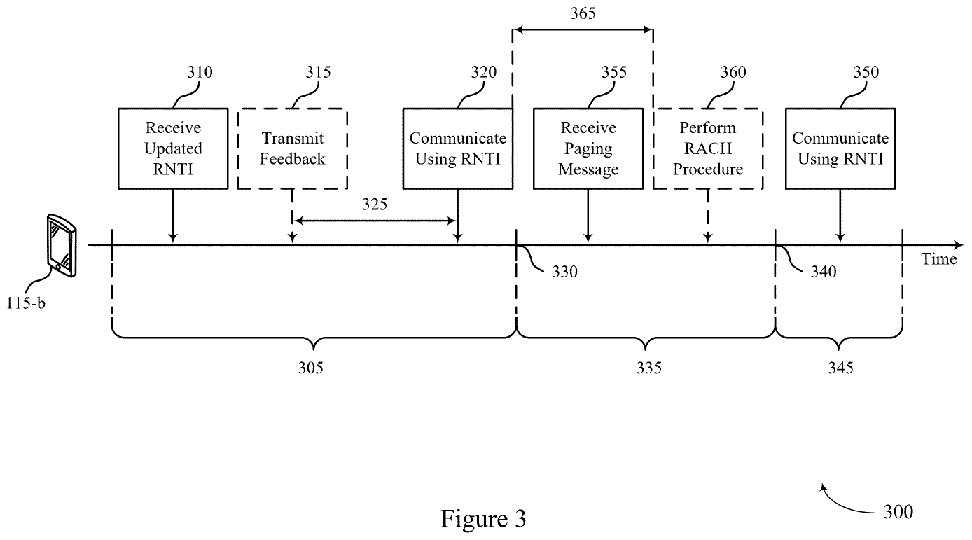

FIG. 3 shows an example of a communication timeline 300 that supports dynamic C-RNTI change for CPE. Aspects of the communication timeline 300 may implement or be implemented by aspects of the wireless communication system 100, the signaling diagram 200, or both. For example, the communication timeline 300 may include a UE 115-b, which may be an example of the UE 115 or the UE 115-a, and a network entity, which may be an example of the network entity 105 or the network entity 105-a.

In some implementations, the network entity may provide configuration information (or delta-configuration) to the UE 115-b while the UE 115-b operates in a first connected state 305 (e.g., RRC connected state), and the UE 115-b may apply the configuration during one or more subsequent connectivity states (e.g., next time the UE connects after an idle/inactive state) without performing full initial access procedures, or the UE 115-a may apply the updated C-RNTI for monitoring control and data (e.g., short messages) while the UE 115-a operates in the idle or inactive mode. For example, the UE 115-a may apply the updated C-RNTI when attempting to connect (e.g., but may not be in connected state yet). In such implementations, the network entity may indicate, as part of the configuration information, an updated C-RNTI value to use during the subsequent connectivity states (e.g., after the UE 115-a transitions to idle/inactive state or after the UE 115-a transitions to connected state again). The configuration may be included in a RRC release message (e.g., RRC message that indicates the UE 115-a is to transition to idle/inactive state from a current connected state).

For example, at 310, the network entity may transmit, and the UE 115-b may receive, the configuration information indicating the updated C-RNTI value. In some examples, the network entity may transmit control signaling including RRC signaling, or lower-layer signaling including DCI or MAC-CE signaling as further described herein with reference to FIG. 2. The network entity may indicate the updated C-RNTI value, and the network entity may indicate one or more timers (e.g., validity timers), which may indicate timing indicative of when the configuration information is applicable (or when the configuration message is expired). For example, the network entity may indicate, via the timers, when the UE 115-b is allowed to use a stored C-RNTI. For example, the UE 115-b may store the updated C-RNTI value, or the UE 115-b may store a different C-RNTI (e.g., latest C-RNTI) value prior to receipt of the updated C-RNTI value at 310, and the UE 115-b may apply the stored C-RNTI value while one or more of the timers are running. In some examples, the UE 115-b may perform initial access procedures to obtain the value of C-RNTI.

In some implementations, the network entity may transmit, via the control signaling, an indication of whether the UE 115-b may apply the stored C-RNTI value during the one or more subsequent connectivity states. In some examples, the UE 115-b may perform the full initial access procedures based on the indication (e.g., based on the indication indicating the UE 115-b may not use the stored C-RNTI value).

In some implementations, the network entity may correspond to a physical cell identifier (PCI). In such implementations, the network entity may transmit the configuration information during the first connected state 305, and the UE 115-b may apply the configuration information during the one or more subsequent connectivity states based on connecting to the network entity associated with the same PCI (valid if UE is connecting to the same PCI). Additionally, or alternatively, the UE 115-b may apply the configuration information based on connecting to one or more cells associated with different PCIs (e.g., from neighbor cell which was the serving cell before). In some examples, the network entity may indicate, via the configuration information, a list of cells, PCIs, or both that the UE 115-b is allowed to connect when using the stored C-RNTI value, or the network entity may indicate a list of pairs of C-RNTI values and PCIs that the UE 115-b may use when trying to connect again (e.g., (C-RNTI, PCI)). For example, the UE 115-b may communicate with a PCI using the stored C-RNTI value based on the stored C-RNTI corresponding to the PCI in accordance with a C-RNIT and PCI pair of the list of C-RNTI and PCI pairs.

For an illustrative example, at 310, the network entity may transmit, and the UE 115-b may receive, control signaling indicating an updated C-RNTI value while the UE 115-b is operating during the first connected state 305. In some examples, at 315, the UE 115-b may transmit feedback associated with the control signaling and the updated C-RNTI value. The control signaling may include an indication of a time to apply the updated C-RNTI value, and the UE 115-b may correspondingly, at 320, apply the updated C-RNTI value after a time delay 325 (e.g., a time indicated by the control signaling), which may be further described herein with reference to FIG. 2. For example, the time delay 325 may be a quantity of time, a quantity of slots or symbols, or the like.

In such examples, at 330, the UE 115-b may transition to operating in an idle state 335 (e.g., an idle or inactive state). In some examples, the UE 115-b may monitor for communications (e.g., DCI) in accordance with the updated C-RNTI value during the idle state 335. At 340, the UE 115-b may transition to a second connected state 345 (e.g., second RRC connected state), and, at 350, the UE 115-b may communicate in accordance with the updated C-RNTI value. For example, the UE 115-b may communicate according to the updated C-RNTI value at 350 based on the control signaling of 310, and in accordance with the one or more timers described herein, among other examples. In some examples, the UE 115-b may utilize the updated C-RNTI value during the transition to the second connected state 345 (e.g., connecting to the cell but not in connected state yet).

Additionally, or alternatively, at 355, the UE 115-b may receive a paging message while operating in the idle state 335 as further described herein with reference to FIG. 2. The UE 115-b may receive, via the paging message, an indication of the updated C-RNTI value, and the UE 115-b may apply the updated C-RNTI value for communications based on transitioning to the second connected state 345 at 340, or the UE 115-b may apply the updated C-RNTI value after transitioning to the second connected state 345 and after an additional timing delay indicated by the paging message, or the like.

In some implementations, the network entity may indicate, via the control signaling of 310, or the like, one or more sets of RACH resources associated with an initial access procedure (e.g., reduced initial access), and the UE 115-b may utilize the RACH resources during subsequent reconnection after an idle or inactive state. In some examples, at 360, the UE 115-a may perform a RACH procedure, which may be a contention free random access (CFRA) procedure, among other examples. The UE 115-b may perform the RACH procedure based on expiration of a timer 365 (e.g., a timer indicated by the control signaling of 310), among other examples.

For example, the UE 115-b may transmit a first message (e.g., MSG1) of the RACH procedure, and, in response to the RACH message, the network entity may transmit a second message (e.g., MSG2 or RAR) indicating to the UE 115-b to continue the full initial access procedure (e.g., whether the “reduced initial access” procedure suffices). For example, the network entity may indicate, via the second message, that the UE 115-b may refrain from performing the full initial access procedure (e.g., the UE 115-b may perform reduced initial access including transmission of PRACH and reception of MSG2/RAR similar to CFRA). In some examples, the network entity may indicate, via the control signaling of 310, multiple updated C-RNTI values (e.g., instead of one updated C-RNTI value), and the network entity may indicate, via the second message of the RACH procedure, one of the multiple updated C-RNTI values to apply (e.g., among the pre-configured multiple RNTI values). For example, the UE 115-b may perform the RACH procedure at 360, and the network entity may indicate one of the multiple C-RNTI values via the second message (e.g., RAR) of the RACH procedure. Accordingly, the UE 115-b may communicate using the indicated updated C-RNTI value at 350.

Particular aspects of the subject matter described in this disclosure can be implemented to realize one or more of the following potential advantages. In some examples, by indicating the updated C-RNTI value via lower-layer signaling, or via paging messages, by indicating timing parameters to associated with future application of the updated C-RNTI values, or both, the described techniques can be used to reduce signaling overhead associated with performing RACH procedures to obtain the updated C-RNTI values, or to improve an efficiency associated with indicating the updated C-RNTI values (e.g., compared to RRC reconfiguration) among other improvements.

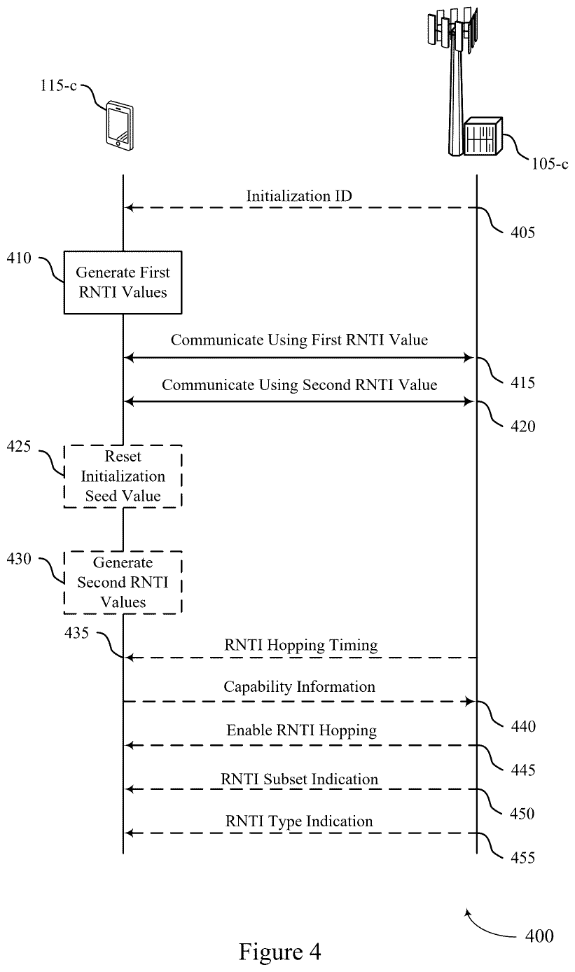

FIG. 4 shows an example of a process flow 400 that supports dynamic C-RNTI change for CPE. Aspects of the process flow 400 may implement or be implemented by aspects of the wireless communication system 100, the signaling diagram 200, or both. For example, the process flow 400 may include a UE 115-c, which may be an example of the UE 115 or the UE 115-a, and a network entity 105-c, which may be an example of the network entity 105 or the network entity 105-a.

In the following description of the process flow 400, the operations between the UE 115-c and the network entity 105-c may be performed in different orders or at different times. Some operations may also be left out of the process flow 400, or other operations may be added. Although the UE 115-c and the network entity 105-c are shown performing the operations of the process flow 400, some aspects of some operations may also be performed by one or more other wireless devices.

In some implementations, the UE 115-c may obtain one or more C-RNTI values (e.g., C-RNTI may change) as a function of time (e.g., t) in accordance with a pseudo-random sequence associated with an initialization value. For example, the UE 115-c may perform C-RNTI hopping in accordance with the pseudo-random sequence. In such implementations, the UE 115-c may obtain an updated C-RNTI value at a time t, or a beginning of a time unit, which may include a slot, subframe, or radio frame, or multiple (M) slots, subframes, or radio frames, where M may be fixed or configured (e.g., RRC-configured). For example, the UE 115-c may obtain the one or more C-RNTI values according to the function of time (e.g., f(t)) based on a function fin accordance with the pseudo-random sequence (e.g., c(i)). In such examples, the UE 115-c may obtain the one or more C-RNTI values further based on an initial C-RNTI value (e.g., cRNTI₀), which may be a C-RNTI value in a previous time unit or a C-RNTI value obtained during an initial access procedure. For example, the UE 115-c may obtain the C-RNTI values based on Equation 1, shown below.

$$c RNTI ( t ) = f ( t ) = [ c {RNTI}_{0} + {\sum }_{i = 0}^{I - 1} ( c ( I \cdot t + i ) \cdot {2}^{i} ) ] mod {2}^{16} \qquad ( 1 )$$

In some implementations, the UE 115-c may initialize the pseudo-random sequence, which may determine (e.g., set or reset) the initial values of the pseudo-random sequence. The UE 115-c may initialize the pseudo-random sequence based on an ID for initialization (e.g., cᵢₙᵢₜ, or an initialization seed value) which may be based on a PCI, or may be configured by the network entity 105-c (e.g., explicitly configured, or RRC-configured).

In some examples, at 405, the network entity 105-c may transmit, and the UE 115-c may receive, an indication of the initialization ID. Additionally, or alternatively, the UE 115-c may obtain the initialization ID based on a PCI (e.g., a PCI of the network entity 105-c), or based on a preconfigured value.

At 410, the UE 115-c may generate the C-RNTI values. In some examples, the UE 115-c may generate the C-RNTI values in accordance with Equation 1 and based on the initialization ID. At 415, the UE 115-c may communicate in accordance with a first C-RNTI value of the generated C-RNTI values, which may be a C-RNTI value generated at a first time t1 in accordance with Equation 1. For an illustrative example, the UE 115-c may generate the first C-RNTI value (e.g., cRNTI₁) at a time t=1, and the UE 115-c may communicate in accordance with the first C-RNTI value. At 420, the UE 115-c may communicate in accordance with a second C-RNTI value at a second time t2, which may be the beginning of a time unit as described herein. For example, the UE 115-c may generate the second C-RNTI value (e.g., cRNTI₂) at a time t=2, and a time between t1 and t2 may include a quantity of slots, a quantity of subframes, a quantity of radio frames, or the like.

In some examples, at 425, the UE 115-c may reset the initialization ID. The UE 115-c may reset the initialization ID at a beginning of a time duration T (e.g., the time t is defined within the time duration T, and the time unit for t may be smaller than T). For example, T may include a radio frame, multiple (e.g., N) radio frames, a hyper-frame, or N hyper frames, where N may be fixed (e.g., preconfigured) or configured (e.g., RRC-configured) by the network entity 105-c. In some examples, the UE 115-c may reset the initialization ID based on N=1024 radio frames, which may correspond to a hyper frame (e.g., 10.24 seconds and coinciding with when SFN is reset). In some examples, the UE 115-c may determine the time T to reset the initialization ID (e.g., initialize the pseudo-random sequence) based on a SFN or a hyper frame number (HFN) (e.g., when SFN mod N=0). In some examples, at 430, the UE 115-c may generate one or more second C-RNTI values based on the reset initialization ID. In some examples, at 435, the network entity 105-c may transmit an indication of RNTI hopping timing information (e.g., control signaling, or RRC signaling), which may include an indication of t, T, or both.

In some examples, the UE 115-c may generate the C-RNTI values based on an initialization ID value (e.g., seed), time duration T for resetting the initialization, or both, which are common to one or more UEs (e.g., CPEs) including the UE 115-c. Accordingly, the UE 115-c may mitigate collisions via the hopping formula based on the common initialization ID, the common time duration T, or both (e.g., assuming the UEs change C-RNTI at the same time t, and there are no collision in the corresponding initial C-RNTI value (cRNTI₀)).

In some examples, at 440, the UE 115-c may transmit capability information (e.g., via capability signaling) indicating support for C-RNTI hopping, and, at 445, the network entity 105-c may transmit signaling enabling the C-RNTI hopping, which may be based on the capability information. For example, the network entity 105-c may enable C-RNTI hopping via a RRC parameter, or the like.

In some implementations, the UE 115-c may perform the C-RNTI hopping according to a subset (e.g., a subspace) of C-RNTI values. In some examples, at 450, the network entity 105-c may transmit an indication of the subset (e.g., via RRC signaling), which may indicate a range of C-RNTI values, or may indicate a bitmap of C-RNTI values (e.g., allowed C-RNTI values), among other examples. Additionally, or alternatively, the UE 115-c may obtain the subset of C-RNTI values based on a preconfigured subset of C-RNTI values. Accordingly, the UE 115-c may generate the C-RNTI values based on the pseudo-random sequence in accordance with the subset such that the generated C-RNTI values are members of the subset of C-RNTI values (e.g., C-RNTI hopping within the subset), which may support coexistence between UEs configured with C-RNTI hopping and other UEs without C-RNTI hopping.

In some implementations, the UE 115-c may perform the C-RNTI hopping according to one or more RNTI types (e.g., the randomization may apply to other RNTIs) including configured scheduling RNTI (CS-RNTI), modulation and coding scheme C-RNTI (MCS-C-RNTI), slot format indication RNTI (SFI-RNTI), transmit power control PUSCH RNTI (TPC-PUSCH-RNTI), transmit power control PUCCH (TPC-PUCCH-RNTI), transmit power control sounding reference signal RNTI (TPC-SRS-RNTI), or the like. In some examples, at 455, the network entity 105-c may transmit signaling (e.g., RRC signaling) indicating the one or more RNTI types, or the one or more RNTI types may be preconfigured. For example, the UE 115-c may perform RNTI hopping according to one or more different RNTI hopping configurations based on the one or more RNTI types (e.g., different time units t, time durations T, initialization IDs, or RNTI value subsets). For an illustrative example, the UE 115-c may perform RNTI hopping according to a first configuration for C-RNTI and a second configuration for SFI-RNTI

Particular aspects of the subject matter described in this disclosure can be implemented to realize one or more of the following potential advantages. In some examples, by indicating the updated C-RNTI value via lower-layer signaling, or via paging messages, by indicating timing parameters to associated with future application of the updated C-RNTI values, or both, the described techniques can be used to reduce signaling overhead associated with performing RACH procedures to obtain the updated C-RNTI values, or to improve an efficiency associated with indicating the updated C-RNTI values (e.g., compared to RRC reconfiguration) among other improvements.

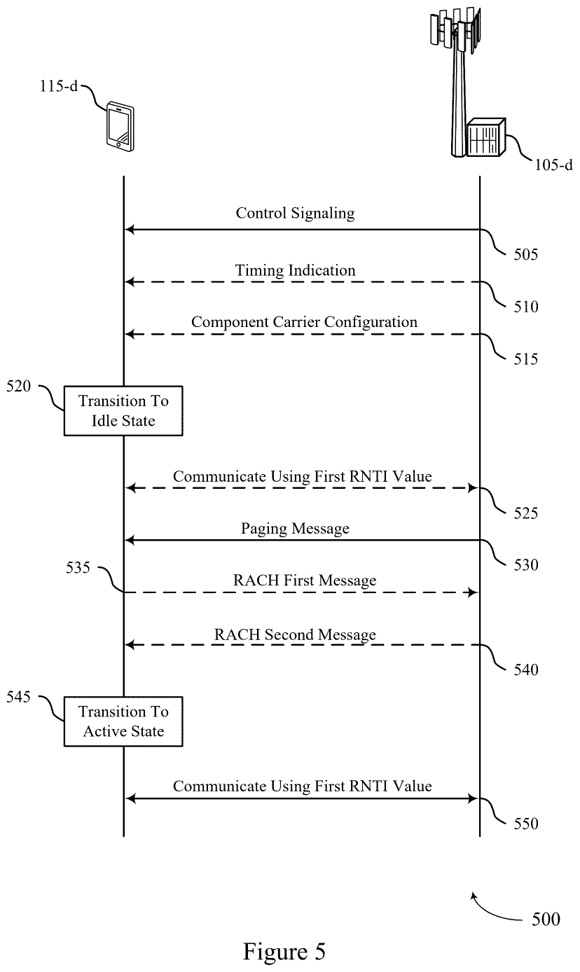

FIG. 5 shows an example of a process flow 500 that supports dynamic C-RNTI change for CPE. Aspects of the process flow 500 may implement or be implemented by aspects of the wireless communication system 100, the signaling diagram 200, or both. Aspects of the process flow 500 may implement or be implemented by aspects of the wireless communication system 100, the signaling diagram 200, or both. For example, the process flow 500 may include a UE 115-d, which may be an example of the UE 115 or the UE 115-a, and a network entity 105-d, which may be an example of the network entity 105 or the network entity 105-a.

In the following description of the process flow 500, the operations between the UE 115-d and the network entity 105-d may be performed in different orders or at different times. Some operations may also be left out of the process flow 500, or other operations may be added. Although the UE 115-d and the network entity 105-d are shown performing the operations of the process flow 500, some aspects of some operations may also be performed by one or more other wireless devices.

At 505, the network entity 105-d may transmit, and the UE 115-d may receive, control signaling (e.g., RRC signaling) indicating a C-RNTI value (e.g., an updated C-RNTI value). In some examples, the UE 115-d may receive the control signaling while operating in a connected state (e.g., a RRC connected state).

In some examples, at 510, the network entity 105-d may transmit, via the RRC signaling, among other examples, a timing indication indicating one or more timing parameters associated with the updated C-RNTI value. For example, the network entity 105-d may indicate a timing delay associated with application of the updated C-RNTI value, one or more timers associated with a duration during which the UE 115-d may apply the updated C-RNTI value or one or more stored (e.g., previous) C-RNTI values, or the like.

In some examples, at 515, the network entity 105-d may transmit, via the RRC signaling, among other examples, configuration information associated with one or more cells, one or more CCs, or both. For example, the network entity 105-d may indicate whether the UE 115-d may communicate in accordance with the updated C-RNTI value based on the UE 115-d communicating with one or more of the indicated cells (e.g., associated with indicated PCIs), indicated CCs, among other examples.

At 520, the UE 115-d may transition to an idle state (e.g., an idle state or an inactive state). In some examples, the UE 115-d may transition to the idle state based on receiving the control signaling of 310 and based on the control signaling including a release message (e.g., RRCRelease). In some examples, at 525, UE 115-d may communicate in accordance with the updated C-RNTI value while operating during the idle duration. For example, the UE 115-d may monitor for DCI messages in accordance with the updated C-RNTI value, among other examples.

At 530, the network entity 105-d may transmit, and the UE 115-d may receive, during the inactive state, a paging message including an indication of the updated C-RNTI value. For example, the network entity 105-d may indicate the updated C-RNTI value via the paging message based on refraining from indicating the updated C-RNTI value during the connected state, or the network entity 105-d may indicate one or more additional updated C-RNTI values via the paging messages.

The UE 115-d may perform a RACH procedure. In some examples, at 535, the UE 115-d may transmit a first message (e.g., MSG1) of the RACH procedure, and, in some examples, at 540, the UE 115-d may receive a second message (e.g., MSG2 or a RAR) of the RACH procedure based on transmitting the first message. The UE 115-d may perform the RACH procedure based on one or more techniques further described herein with reference to FIG. 2.

At 545, the UE 115-d may transmit to the connected state (e.g., a second connected state subsequent to a first connected state), and, at 550, the UE 115-d may communicate in accordance with the updated C-RNTI value. For example, the UE 115-d may communicate in accordance with the updated C-RNTI value based on receiving the control signaling of 505, the paging message of 530, or both, and the UE 115-d may communicate in accordance with the updated C-RNTI value based on one or more timing parameters described herein.

Particular aspects of the subject matter described in this disclosure can be implemented to realize one or more of the following potential advantages. In some examples, by indicating the updated C-RNTI value via lower-layer signaling, or via paging messages, by performing the C-RNTI hopping, the described techniques can be used to reduce signaling overhead associated with performing RACH procedures to obtain the updated C-RNTI values, among other improvements. Additionally, or alternatively, by performing the C-RNTI hopping, the UE 115-d may achieve randomization of the updated C-RNTI values, which may mitigate security concerns related to eavesdropping devices.

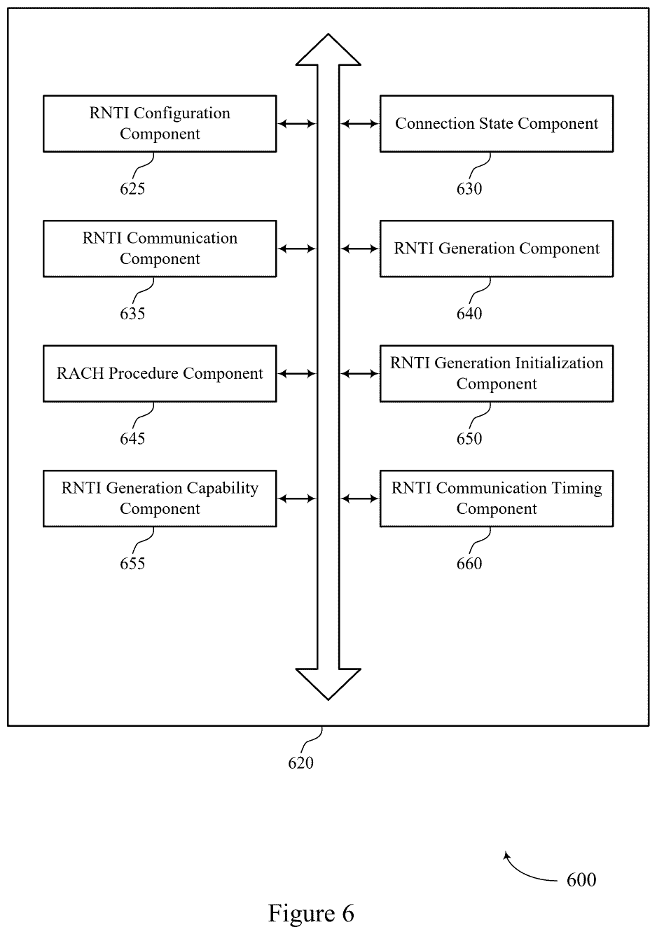

FIG. 6 shows an example of a processing system 600 that supports dynamic C-RNTI change for CPE. A processing system 620 may be an example of a processing system 140 (such as of a UE 115) and may include an RNTI configuration component 625, a connection state component 630, an RNTI communication component 635, an RNTI generation component 640, a RACH procedure component 645, an RNTI generation initialization component 650, an RNTI generation capability component 655, an RNTI communication timing component 660, or any combination thereof. A processing system 620, or various component thereof, may be an example of means for performing (such as a means for causing a UE 115 to perform) various techniques described herein.

The RNTI configuration component 625 may be configured to cause the UE 115 to receive control signaling including an indication of a first RNTI value, where receipt of the control signaling occurs while the UE is in a first RRC connected state. The connection state component 630 may be configured to cause the UE 115 to transition to an idle state or an inactive state after receipt of the control signaling. The RNTI communication component 635 may be configured to cause the UE 115 to communicate with a network entity after being in the idle state or the inactive state, where one or more communications with the network entity are based on the first RNTI value.

In some examples, the control signaling includes a release message. In some examples, the control signaling indicates that the UE is to transition to the idle state or to the inactive state.

In some examples, the control signaling is further indicative of one or more timers which indicate a duration of time during which the UE is permitted to use the first RNTI value. In some examples, communicating with the network entity based on the first RNTI value after the UE is in the idle state or the inactive state is further based on satisfaction of the one or more timers.

In some examples, the RNTI communication component 635 may be configured to cause the UE 115 to communicate in accordance with the first RNTI value while the UE is in the first RRC connected state, where the control signaling is further indicative of a permission for the UE to communicate in accordance with the first RNTI value after the UE transitions from the first RRC connected state.

In some examples, the control signaling is further indicative of one or more cells for communication. In some examples, communicating with the network entity based on the first RNTI value includes communicating with a cell of the one or more indicated cells for communication.

In some examples, the control signaling is received from a first cell associated with a first PCI. In some examples, communicating with the network entity based on the first RNTI value is based on the network entity being associated with the first PCI.

In some examples, the control signaling is further indicative of one or more resource sets associated with a RACH procedure, and the RACH procedure component 645 may be configured to cause the UE 115 to perform a first portion of the RACH procedure in accordance with the one or more resource sets, the first portion of the RACH procedure including a first message transmission and a second message reception, where the second message is indicative that the UE is to perform a second portion of the RACH procedure, is indicative of one or more additional RNTI values different from the first RNTI value, or both.

In some examples, the first portion of the RACH procedure corresponds to a contention-free RACH procedure.

In some examples, the first RNTI value is one of a set of multiple RNTI values indicated by the control signaling. In some examples, the second message indicates whether the UE is to proceed or refrain from proceeding with the second portion of the RACH procedure, that the UE is to use the first RNTI value in the one or more communications with the network entity, or both.

Additionally, or alternatively, the RNTI generation component 640 may be configured to cause the UE 115 to generate a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value. In some examples, the RNTI communication component 635 may be configured to cause the UE 115 to communicate in accordance with a first RNTI value of the first set of multiple RNTI values at a first instance of time based on the pseudo-random sequence generator. In some examples, the RNTI communication component 635 may be configured to cause the UE 115 to communicate in accordance with one or more second RNTI values of the first set of multiple RNTI values at corresponding one or more second instances of time based on the pseudo-random sequence generator.

In some examples, the RNTI generation initialization component 650 may be configured to cause the UE 115 to receive initialization information that is indicative of the first initialization seed value for the pseudo-random sequence generator.

In some examples, individual ones of the first instance of time and the one or more second instances of time are separated by a duration, the duration including a quantity of slots, a subframe, a radio frame, or any combination thereof.

In some examples, the RNTI communication timing component 660 may be configured to cause the UE 115 to receive control signaling that indicates the duration.

In some examples, the RNTI generation initialization component 650 may be configured to cause the UE 115 to reset a current value of the first initialization seed value to an initial value of the first initialization seed value. In some examples, the RNTI generation component 640 may be configured to cause the UE 115 to generate one or more second pluralities of RNTI values based on an updated initial RNTI value and an additional pseudo-random sequence, where the pseudo-random sequence generator generates the one or more second pluralities of RNTI values based on the additional pseudo-random sequence in accordance with the function of time and the reset initial value of the first initialization seed value, and where each of the first initialization seed value and the reset initial value of the first initialization seed value are applied at corresponding initialization times.

In some examples, the corresponding initialization times are each separated by a first duration. In some examples, the first duration includes a quantity of radio frames, is in accordance with a SFN, or both. In some examples, the first duration is greater than or equal to a second duration that separates individual ones of the first instance of time and the one or more second instances of time.

In some examples, the RNTI communication timing component 660 may be configured to cause the UE 115 to receive control signaling indicating the first duration, the second duration, or both.

In some examples, the RNTI generation capability component 655 may be configured to cause the UE 115 to transmit capability information indicating an ability of the UE to operate in accordance with the first set of multiple RNTI values based on the pseudo-random sequence generator. In some examples, the RNTI generation capability component 655 may be configured to cause the UE 115 to receive control signaling including an indication to operate in accordance with the first set of multiple RNTI values based on the pseudo-random sequence generator, where the control signaling is based on the capability information.

In some examples, the RNTI configuration component 625 may be configured to cause the UE 115 to receive control signaling indicating a first set of allowable RNTI values permitted for communication, where the first set of multiple RNTI values is in accordance with the first set of allowable RNTI values, where the first set of allowable RNTI values is associated with the UE and is different from a second set of allowable RNTI values associated with one or more additional UEs.

In some examples, the RNTI configuration component 625 may be configured to cause the UE 115 to receive control signaling that indicates a type of the first set of multiple RNTI values for which the pseudo-random sequence generator is to be used, where the type is one of a cell RNTI (C-RNTI), a configured scheduling RNTI (CS-RNTI), a modulation and coding scheme C-RNTI (MCS-C-RNTI), a slot format indication RNTI (SFI-RNTI), a transmit power control for physical uplink shared channel RNTI (TPC PUSCH-RNTI), a transmit power control for physical uplink control channel RNTI (TPC PUCCH-RNTI), or a transmit power control sounding reference signal RNTI (TPC SRS-RNTI).

In some examples, the RNTI configuration component 625 may be configured to cause the UE 115 to receive signaling that includes an indication of a first RNTI value, where receipt of the signaling occurs while the UE is in an RRC idle state or an RRC inactive state, and where the signaling includes a paging message. In some examples, the connection state component 630 may be configured to cause the UE 115 to transition to an active state after receipt of the signaling. In some examples, the RNTI communication component 635 may be configured to cause the UE 115 to communicate with a network entity after transitioning to the active state, where one or more communications with the network entity are based on the first RNTI.

In some examples, the RNTI communication timing component 660 may be configured to cause the UE 115 to receive timing information that indicates a time for the UE to apply the first RNTI value, where communicating with the network entity using the first RNTI value is in accordance with the indicated time.

In some examples, the indicated time to apply the first RNTI value is with respect to a timing of the transition to the active state or a timing of transmission of associated feedback that corresponds with the signaling. In some examples, the indicated time is indicated in terms of a quantity of symbols, a quantity of slots, a quantity of time, or any combination thereof.

In some examples, the RNTI configuration component 625 may be configured to cause the UE 115 to receive, via the signaling, an indication of one or more CCs associated with the first RNTI value, where communicating in accordance with the first RNTI value is based on communicating via a CC of the one or more indicated CCs.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for reduced latency, improved user experience related to reduced processing, improved coordination between devices, or improved utilization of processing capability, among other improvements.

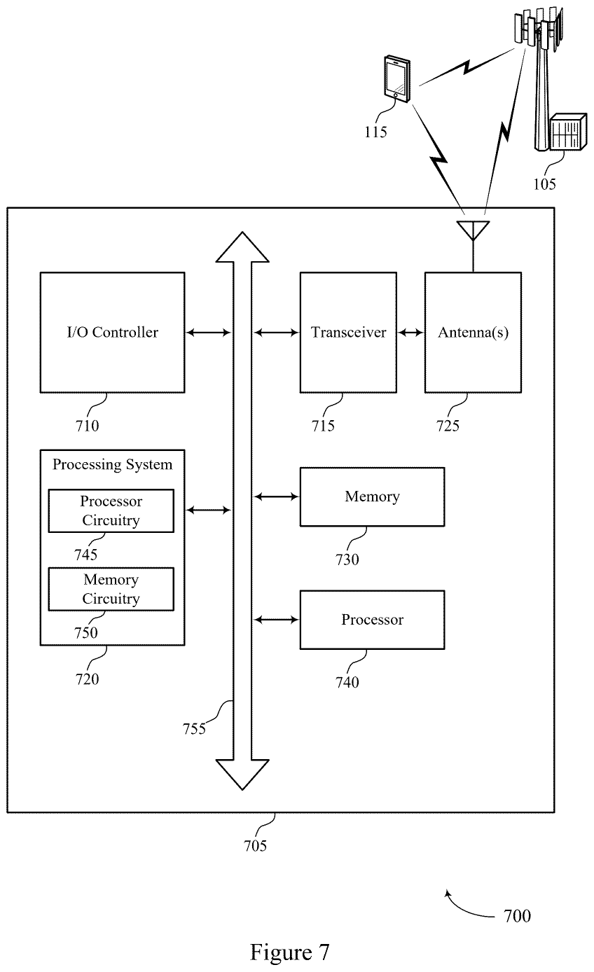

FIG. 7 shows an example of a system 700 including a device 705 that supports dynamic C-RNTI change for CPE. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support dynamic C-RNTI change for CPE. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for reduced latency, improved user experience related to reduced processing, improved coordination between devices, or improved utilization of processing capability, among other improvements.

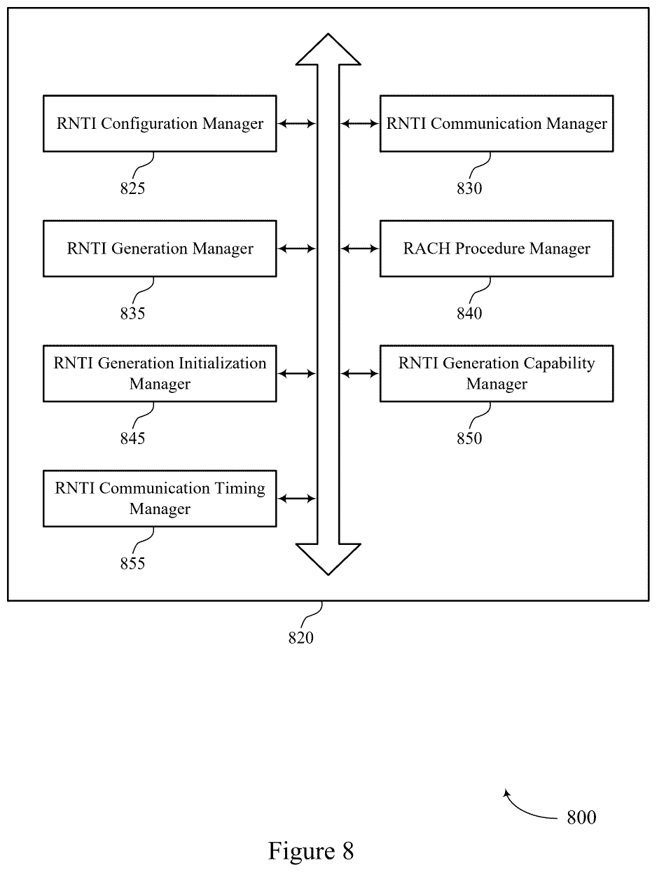

FIG. 8 shows an example of a processing system 800 that supports dynamic C-RNTI change for CPE. A processing system 820 may be an example of a processing system 145 (such as network entity 105) and may include an RNTI configuration manager 825, an RNTI communication manager 830, an RNTI generation manager 835, a RACH procedure manager 840, an RNTI generation initialization manager 845, an RNTI generation capability manager 850, an RNTI communication timing manager 855, or any combination thereof. A processing system 820, or various component thereof, may be an example of means for performing (such as a means for causing a network entity 105 to perform) various techniques described herein.

The RNTI configuration manager 825 may be configured to cause the network entity 105 to transmit control signaling including an indication of a first RNTI value, where receipt of the control signaling occurs while a UE is in a first RRC connected state. The RNTI communication manager 830 may be configured to cause the network entity 105 to communicate with a UE after the UE operates in an idle state or an inactive state, where one or more communications with the UE are based on the first RNTI value.

In some examples, the control signaling includes a release message. In some examples, the control signaling indicates that the UE is to transition to the idle state or to the inactive state.

In some examples, the control signaling is further indicative of one or more timers which indicate a duration of time during which the UE is permitted to use the first RNTI value. In some examples, communicating with the UE based on the first RNTI value after the UE is in the idle state or the inactive state is further based on satisfaction of the one or more timers.

In some examples, the RNTI communication manager 830 may be configured to cause the network entity 105 to communicate in accordance with the first RNTI value while the UE is in the first RRC connected state, where the control signaling is further indicative of a permission for the UE to communicate in accordance with the first RNTI value after the UE transitions from the first RRC connected state.

In some examples, the control signaling is further indicative of one or more resource sets associated with a RACH procedure, and the RACH procedure manager 840 may be configured to cause the network entity 105 to perform a first portion of the RACH procedure in accordance with the one or more resource sets, the first portion of the RACH procedure including a first message reception and a second message transmission, where the second message is indicative that the UE is to perform a second portion of the RACH procedure, is indicative of one or more additional RNTI values different from the first RNTI value, or both.

In some examples, the first portion of the RACH procedure corresponds to a contention-free RACH procedure.

In some examples, the first RNTI value is one of a set of multiple RNTI values indicated by the control signaling. In some examples, the second message indicates whether the UE is to proceed or refrain from proceeding with the second portion of the RACH procedure, that the UE is to use the first RNTI value in the one or more communications with the UE, or both.

Additionally, or alternatively, the RNTI generation manager 835 may be configured to cause the network entity 105 to communicate in accordance with a first RNTI value of a first set of multiple RNTI values at a first instance of time, where a pseudo-random sequence generator generates the first set of multiple RNTI values in accordance with a pseudo-random sequence as a function of time and a first initialization seed value. In some examples, the RNTI communication manager 830 may be configured to cause the network entity 105 to communicate with a UE in accordance with one or more second RNTI values of the first set of multiple RNTI values at corresponding one or more second instances of time based on the pseudo-random sequence generator.

In some examples, the RNTI generation initialization manager 845 may be configured to cause the network entity 105 to transmit initialization information that is indicative of the first initialization seed value for the pseudo-random sequence generator.

In some examples, individual ones of the first instance of time and the one or more second instances of time are separated by a duration, the duration including a quantity of slots, a subframe, a radio frame, or any combination thereof.

In some examples, the RNTI communication timing manager 855 may be configured to cause the network entity 105 to transmit control signaling that indicates the duration.

In some examples, the RNTI generation capability manager 850 may be configured to cause the network entity 105 to receive capability information indicating an ability of the UE to operate in accordance with the first set of multiple RNTI values based on the pseudo-random sequence generator. In some examples, the RNTI generation capability manager 850 may be configured to cause the network entity 105 to transmit control signaling including an indication to operate in accordance with the first set of multiple RNTI values based on the pseudo-random sequence generator, where the control signaling is based on the capability information.

In some examples, the RNTI configuration manager 825 may be configured to cause the network entity 105 to transmit control signaling indicating a first set of allowable RNTI values permitted for communication, where the first set of multiple RNTI values is in accordance with the first set of allowable RNTI values, where the first set of allowable RNTI values is associated with the UE and is different from a second set of allowable RNTI values associated with one or more additional UEs.

In some examples, the RNTI configuration manager 825 may be configured to cause the network entity 105 to transmit control signaling that indicates a type of the first set of multiple RNTI values for which the pseudo-random sequence generator is to be used, where the type is one of a cell RNTI (C-RNTI), a configured scheduling RNTI (CS-RNTI), a modulation and coding scheme C-RNTI (MCS-C-RNTI), a slot format indication RNTI (SFI-RNTI), a transmit power control for physical uplink shared channel RNTI (TPC PUSCH-RNTI), a transmit power control for physical uplink control channel RNTI (TPC PUCCH-RNTI), or a transmit power control sounding reference signal RNTI (TPC SRS-RNTI).

In some examples, the RNTI configuration manager 825 may be configured to cause the network entity 105 to transmit signaling that includes an indication of a first RNTI value, where receipt of the signaling occurs while a UE is in an RRC idle state or an RRC inactive state, and where the signaling includes a paging message. In some examples, the RNTI communication manager 830 may be configured to cause the network entity 105 to communicate with the UE after the UE transitions to an active state after receipt of the signaling and after subsequently transitioning to the active state, where one or more communications with the UE are based on the first RNTI.

In some examples, the RNTI communication timing manager 855 may be configured to cause the network entity 105 to transmit timing information that indicates a time for the UE to apply the first RNTI value, where communicating with the UE using the first RNTI value is in accordance with the indicated time.

In some examples, the indicated time to apply the first RNTI value is with respect to a timing of the transition to the active state or a timing of transmission of associated feedback that corresponds with the signaling. In some examples, the indicated time is indicated in terms of a quantity of symbols, a quantity of slots, a quantity of time, or any combination thereof.

In some examples, the RNTI configuration manager 825 may be configured to cause the network entity 105 to transmit, via the signaling, an indication of one or more CCs associated with the first RNTI value, where communicating in accordance with the first RNTI value is based on communicating via a CC of the one or more indicated CCs.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for reduced latency, improved user experience related to reduced processing, improved coordination between devices, or improved utilization of processing capability, among other improvements.

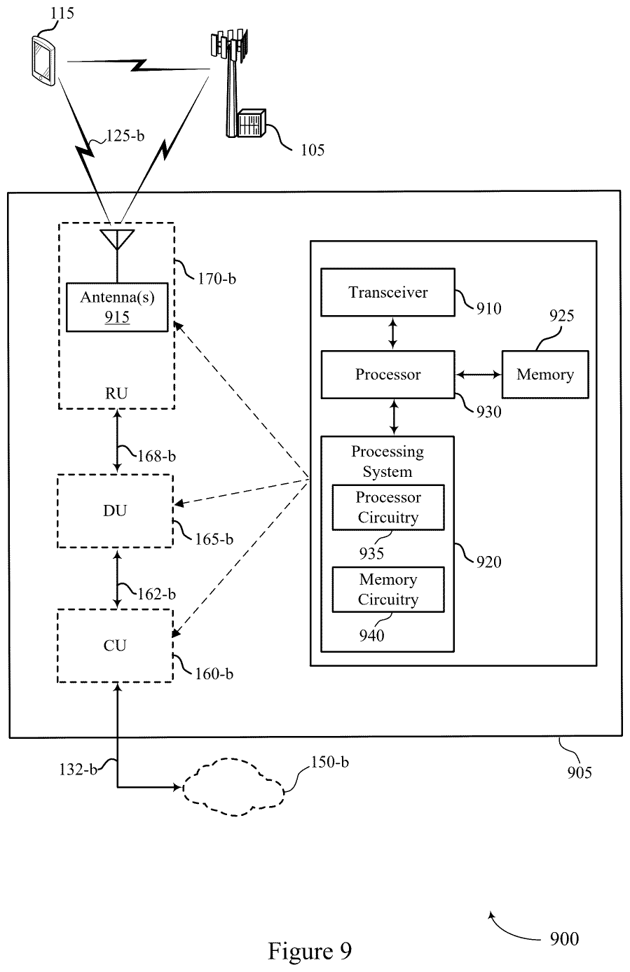

FIG. 9 shows an example of a system 900 including a device 905 that supports dynamic C-RNTI change for CPE. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 800. For example, the processing system 920 may include processor circuitry 935 and memory circuitry 940 that stores code, and the processing system 920 may be configured to cause the device 905 to perform operations that support dynamic C-RNTI change for CPE. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for reduced latency, improved user experience related to reduced processing, improved coordination between devices, or improved utilization of processing capability, among other improvements.

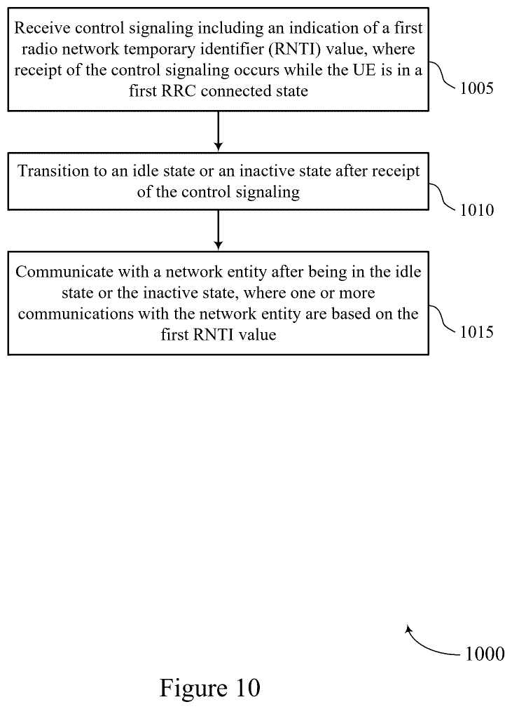

FIG. 10 shows an example of a method 1000 that supports dynamic C-RNTI change for CPE. Operations of the method 1000 may be performed by a UE or its components (such as using a processing system configured to cause the UE 115 to perform one or more of the operations) as described herein.

At 1005, the method may include receiving control signaling including an indication of a first RNTI value, where receipt of the control signaling occurs while the UE is in a first RRC connected state. In some examples, aspects of the operations of 1005 may be performed by an RNTI configuration component 625.

At 1010, the method may include transitioning to an idle state or an inactive state after receipt of the control signaling. In some examples, aspects of the operations of 1010 may be performed by a connection state component 630.

At 1015, the method may include communicating with a network entity after being in the idle state or the inactive state, where one or more communications with the network entity are based on the first RNTI value. In some examples, aspects of the operations of 1015 may be performed by an RNTI communication component 635.

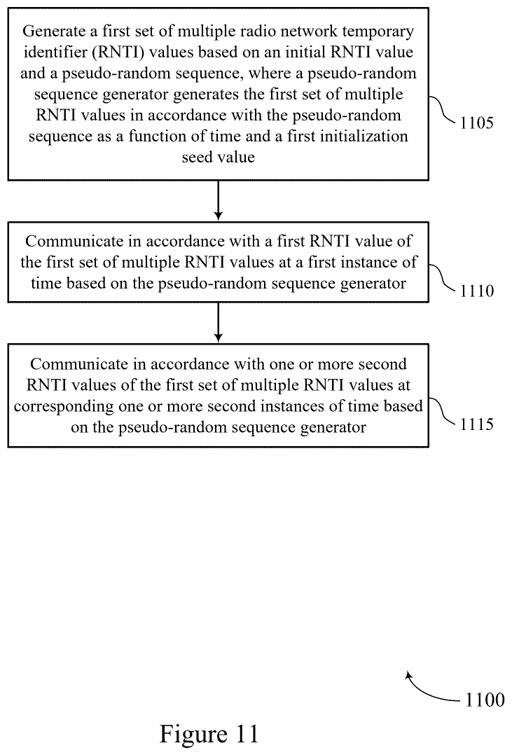

FIG. 11 shows an example of a method 1100 that supports dynamic C-RNTI change for CPE. Operations of the method 1100 may be performed by a UE or its components (such as using a processing system configured to cause the UE 115 to perform one or more of the operations) as described herein.

At 1105, the method may include generating a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value. In some examples, aspects of the operations of 1105 may be performed by an RNTI generation component 640.

At 1110, the method may include communicating in accordance with a first RNTI value of the first set of multiple RNTI values at a first instance of time based on the pseudo-random sequence generator. In some examples, aspects of the operations of 1110 may be performed by an RNTI communication component 635.

At 1115, the method may include communicating in accordance with one or more second RNTI values of the first set of multiple RNTI values at corresponding one or more second instances of time based on the pseudo-random sequence generator. In some examples, aspects of the operations of 1115 may be performed by an RNTI communication component 635.

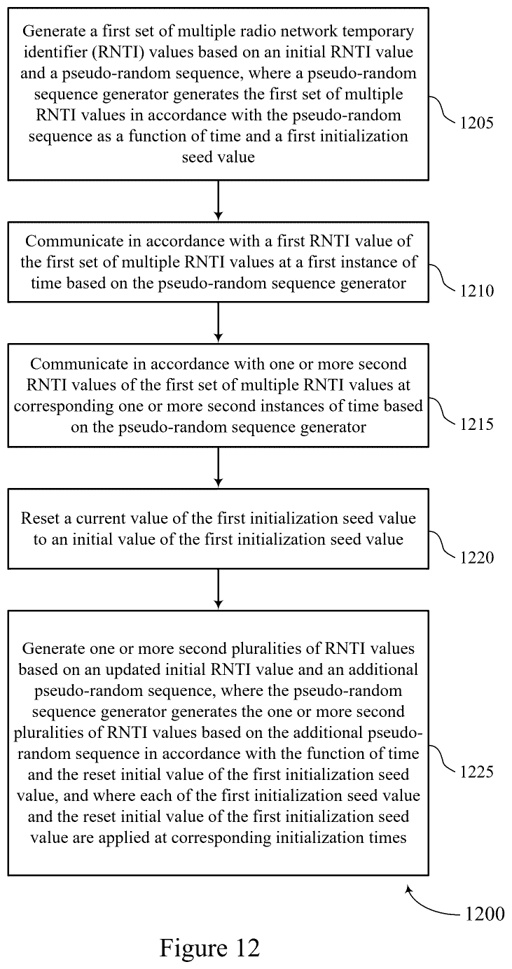

FIG. 12 shows an example of a method 1200 that supports dynamic C-RNTI change for CPE. Operations of the method 1200 may be performed by a UE or its components (such as using a processing system configured to cause the UE 115 to perform one or more of the operations) as described herein.

At 1205, the method may include generating a first set of multiple RNTI values based on an initial RNTI value and a pseudo-random sequence, where a pseudo-random sequence generator generates the first set of multiple RNTI values in accordance with the pseudo-random sequence as a function of time and a first initialization seed value. In some examples, aspects of the operations of 1205 may be performed by an RNTI generation component 640.

At 1210, the method may include communicating in accordance with a first RNTI value of the first set of multiple RNTI values at a first instance of time based on the pseudo-random sequence generator. In some examples, aspects of the operations of 1210 may be performed by an RNTI communication component 635.

At 1215, the method may include communicating in accordance with one or more second RNTI values of the first set of multiple RNTI values at corresponding one or more second instances of time based on the pseudo-random sequence generator. In some examples, aspects of the operations of 1215 may be performed by an RNTI communication component 635.

At 1220, the method may include resetting a current value of the first initialization seed value to an initial value of the first initialization seed value. In some examples, aspects of the operations of 1220 may be performed by an RNTI generation initialization component 650.

At 1225, the method may include generating one or more second pluralities of RNTI values based on an updated initial RNTI value and an additional pseudo-random sequence, where the pseudo-random sequence generator generates the one or more second pluralities of RNTI values based on the additional pseudo-random sequence in accordance with the function of time and the reset initial value of the first initialization seed value, and where each of the first initialization seed value and the reset initial value of the first initialization seed value are applied at corresponding initialization times. In some examples, aspects of the operations of 1225 may be performed by an RNTI generation component 640.

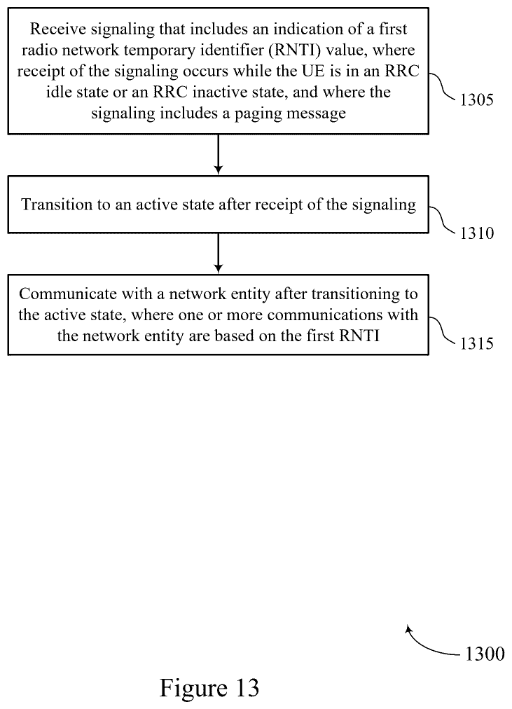

FIG. 13 shows an example of a method 1300 that supports dynamic C-RNTI change for CPE. Operations of the method 1300 may be performed by a UE or its components (such as using a processing system configured to cause the UE 115 to perform one or more of the operations) as described herein.

At 1305, the method may include receiving signaling that includes an indication of a first RNTI value, where receipt of the signaling occurs while the UE is in an RRC idle state or an RRC inactive state, and where the signaling includes a paging message. In some examples, aspects of the operations of 1305 may be performed by an RNTI configuration component 625.

At 1310, the method may include transitioning to an active state after receipt of the signaling. In some examples, aspects of the operations of 1310 may be performed by a connection state component 630.

At 1315, the method may include communicating with a network entity after transitioning to the active state, where one or more communications with the network entity are based on the first RNTI. In some examples, aspects of the operations of 1315 may be performed by an RNTI communication component 635.

Implementation examples are described in the following numbered clauses:

Aspect 1: A method for wireless communications at a UE, comprising: receiving control signaling comprising an indication of a first RNTI value, wherein receipt of the control signaling occurs while the UE is in a first RRC connected state; transitioning to an idle state or an inactive state after receipt of the control signaling; and communicating with a network entity after being in the idle state or the inactive state, wherein one or more communications with the network entity are based at least in part on the first RNTI value.

Aspect 2: The method of aspect 1, wherein the control signaling comprises a release message, and the control signaling indicates that the UE is to transition to the idle state or to the inactive state.

Aspect 3: The method of any of aspects 1 through 2, wherein the control signaling is further indicative of one or more timers which indicate a duration of time during which the UE is permitted to use the first RNTI value, and communicating with the network entity based at least in part on the first RNTI value after the UE is in the idle state or the inactive state is further based on satisfaction of the one or more timers.

Aspect 4: The method of any of aspects 1 through 3, further comprising: communicating in accordance with the first RNTI value while the UE is in the first RRC connected state, wherein the control signaling is further indicative of a permission for the UE to communicate in accordance with the first RNTI value after the UE transitions from the first RRC connected state.

Aspect 5: The method of any of aspects 1 through 4, wherein the control signaling is further indicative of one or more cells for communication, communicating with the network entity based at least in part on the first RNTI value includes communicating with a cell of the one or more indicated cells for communication.

Aspect 6: The method of any of aspects 1 through 5, wherein the control signaling is received from a first cell associated with a first PCI, and communicating with the network entity based at least in part on the first RNTI value is based at least in part on the network entity being associated with the first PCI.

Aspect 7: The method of any of aspects 1 through 6, wherein the control signaling is further indicative of one or more resource sets associated with a RACH procedure, wherein the method further comprises: performing a first portion of the RACH procedure in accordance with the one or more resource sets, the first portion of the RACH procedure including a first message transmission and a second message reception, wherein the second message is indicative that the UE is to perform a second portion of the RACH procedure, is indicative of one or more additional RNTI values different from the first RNTI value, or both.

Aspect 8: The method of aspect 7, wherein the first portion of the RACH procedure corresponds to a contention-free RACH procedure.

Aspect 9: The method of any of aspects 7 through 8, wherein the first RNTI value is one of a plurality of RNTI values indicated by the control signaling, and the second message indicates whether the UE is to proceed or refrain from proceeding with the second portion of the RACH procedure, that the UE is to use the first RNTI value in the one or more communications with the network entity, or both.

Aspect 10: A method for wireless communications at a UE, comprising: generating a first plurality of RNTI values based at least in part on an initial RNTI value and a pseudo-random sequence, wherein a pseudo-random sequence generator generates the first plurality of RNTI values in accordance with the pseudo-random sequence as a function of time and a first initialization seed value; communicating in accordance with a first RNTI value of the first plurality of RNTI values at a first instance of time based at least in part on the pseudo-random sequence generator; and communicating in accordance with one or more second RNTI values of the first plurality of RNTI values at corresponding one or more second instances of time based at least in part on the pseudo-random sequence generator.

Aspect 11: The method of aspect 10, further comprising: receiving initialization information that is indicative of the first initialization seed value for the pseudo-random sequence generator.

Aspect 12: The method of any of aspects 10 through 11, wherein individual ones of the first instance of time and the one or more second instances of time are separated by a duration, the duration comprising a quantity of slots, a subframe, a radio frame, or any combination thereof.

Aspect 13: The method of aspect 12, further comprising: receiving control signaling that indicates the duration.

Aspect 14: The method of any of aspects 10 through 13, further comprising: resetting a current value of the first initialization seed value to an initial value of the first initialization seed value; and generating one or more second pluralities of RNTI values based at least in part on an updated initial RNTI value and an additional pseudo-random sequence, wherein the pseudo-random sequence generator generates the one or more second pluralities of RNTI values based at least in part on the additional pseudo-random sequence in accordance with the function of time and the reset initial value of the first initialization seed value, and wherein each of the first initialization seed value and the reset initial value of the first initialization seed value are applied at corresponding initialization times.

Aspect 15: The method of aspect 14, wherein the corresponding initialization times are each separated by a first duration, the first duration comprises a quantity of radio frames, is in accordance with a SFN, or both, and the first duration is greater than or equal to a second duration that separates individual ones of the first instance of time and the one or more second instances of time.

Aspect 16: The method of aspect 15, further comprising: receiving control signaling indicating the first duration, the second duration, or both.

Aspect 17: The method of any of aspects 10 through 16, further comprising: transmitting capability information indicating an ability of the UE to operate in accordance with the first plurality of RNTI values based at least in part on the pseudo-random sequence generator; and receiving control signaling comprising an indication to operate in accordance with the first plurality of RNTI values based at least in part on the pseudo-random sequence generator, wherein the control signaling is based at least in part on the capability information.

Aspect 18: The method of any of aspects 10 through 17, further comprising: receiving control signaling indicating a first set of allowable RNTI values permitted for communication, wherein the first plurality of RNTI values is in accordance with the first set of allowable RNTI values, wherein the first set of allowable RNTI values is associated with the UE and is different from a second set of allowable RNTI values associated with one or more additional UEs.

Aspect 19: The method of any of aspects 10 through 18, further comprising: receiving control signaling that indicates a type of the first plurality of RNTI values for which the pseudo-random sequence generator is to be used, wherein the type is one of a C-RNTI, a CS-RNTI, a MCS-C-RNTI, a SFI-RNTI, a TPC PUSCH-RNTI, a TPC PUCCH-RNTI, or a TPC SRS-RNTI.

Aspect 20: A method for wireless communications at a UE, comprising: receiving signaling that comprises an indication of a first RNTI value, wherein receipt of the signaling occurs while the UE is in an RRC idle state or an RRC inactive state, and wherein the signaling comprises a paging message; transitioning to an active state after receipt of the signaling; and communicating with a network entity after transitioning to the active state, where one or more communications with the network entity are based at least in part on the first RNTI.

Aspect 21: The method of aspect 20, further comprising: receiving timing information that indicates a time for the UE to apply the first RNTI value, wherein communicating with the network entity using the first RNTI value is in accordance with the indicated time.

Aspect 22: The method of aspect 21, wherein the indicated time to apply the first RNTI value is with respect to a timing of the transition to the active state or a timing of transmission of associated feedback that corresponds with the signaling, the indicated time is indicated in terms of a quantity of symbols, a quantity of slots, a quantity of time, or any combination thereof.

Aspect 23: The method of any of aspects 20 through 22, further comprising: receiving, via the signaling, an indication of one or more CCs associated with the first RNTI value, wherein communicating in accordance with the first RNTI value is based at least in part on communicating via a CC of the one or more indicated CCs.

Aspect 24: A method for wireless communications at a network entity, comprising: transmitting control signaling comprising an indication of a first RNTI value, wherein receipt of the control signaling occurs while a UE is in a first RRC connected state; and communicating with a UE after the UE operates in an idle state or an inactive state, wherein one or more communications with the UE are based at least in part on the first RNTI value.

Aspect 25: The method of aspect 24, wherein the control signaling comprises a release message, and the control signaling indicates that the UE is to transition to the idle state or to the inactive state.

Aspect 26: The method of any of aspects 24 through 25, wherein the control signaling is further indicative of one or more timers which indicate a duration of time during which the UE is permitted to use the first RNTI value, and communicating with the UE based at least in part on the first RNTI value after the UE is in the idle state or the inactive state is further based on satisfaction of the one or more timers.

Aspect 27: The method of any of aspects 24 through 26, further comprising: communicating in accordance with the first RNTI value while the UE is in the first RRC connected state, wherein the control signaling is further indicative of a permission for the UE to communicate in accordance with the first RNTI value after the UE transitions from the first RRC connected state.

Aspect 28: The method of any of aspects 24 through 27, wherein the control signaling is further indicative of one or more resource sets associated with a RACH procedure, wherein the method further comprises: performing a first portion of the RACH procedure in accordance with the one or more resource sets, the first portion of the RACH procedure including a first message reception and a second message transmission, wherein the second message is indicative that the UE is to perform a second portion of the RACH procedure, is indicative of one or more additional RNTI values different from the first RNTI value, or both.

Aspect 29: The method of aspect 28, wherein the first portion of the RACH procedure corresponds to a contention-free RACH procedure.

Aspect 30: The method of any of aspects 28 through 29, wherein the first RNTI value is one of a plurality of RNTI values indicated by the control signaling, and the second message indicates whether the UE is to proceed or refrain from proceeding with the second portion of the RACH procedure, that the UE is to use the first RNTI value in the one or more communications with the UE, or both.

Aspect 31: A method for wireless communications at a network entity, comprising: communicating in accordance with a first RNTI value of a first plurality of RNTI values at a first instance of time, wherein a pseudo-random sequence generator generates the first plurality of RNTI values in accordance with a pseudo-random sequence as a function of time and a first initialization seed value; and communicating with a UE in accordance with one or more second RNTI values of the first plurality of RNTI values at corresponding one or more second instances of time based at least in part on the pseudo-random sequence generator.

Aspect 32: The method of aspect 31, further comprising: transmitting initialization information that is indicative of the first initialization seed value for the pseudo-random sequence generator.

Aspect 33: The method of any of aspects 31 through 32, wherein individual ones of the first instance of time and the one or more second instances of time are separated by a duration, the duration comprising a quantity of slots, a subframe, a radio frame, or any combination thereof.

Aspect 34: The method of aspect 33, further comprising: transmitting control signaling that indicates the duration.

Aspect 35: The method of any of aspects 31 through 34, further comprising: receiving capability information indicating an ability of the UE to operate in accordance with the first plurality of RNTI values based at least in part on the pseudo-random sequence generator; and transmitting control signaling comprising an indication to operate in accordance with the first plurality of RNTI values based at least in part on the pseudo-random sequence generator, wherein the control signaling is based at least in part on the capability information.

Aspect 36: The method of any of aspects 31 through 35, further comprising: transmitting control signaling indicating a first set of allowable RNTI values permitted for communication, wherein the first plurality of RNTI values is in accordance with the first set of allowable RNTI values, wherein the first set of allowable RNTI values is associated with the UE and is different from a second set of allowable RNTI values associated with one or more additional UEs.

Aspect 37: The method of any of aspects 31 through 36, further comprising: transmitting control signaling that indicates a type of the first plurality of RNTI values for which the pseudo-random sequence generator is to be used, wherein the type is one of a C-RNTI, a CS-RNTI, a MCS-C-RNTI, a SFI-RNTI, a TPC PUSCH-RNTI, a TPC PUCCH-RNTI, or a TPC SRS-RNTI.

Aspect 38: A method for wireless communications at a network entity, comprising: transmitting signaling that comprises an indication of a first RNTI value, wherein receipt of the signaling occurs while a UE is in an RRC idle state or an RRC inactive state, and wherein the signaling comprises a paging message; and communicating with the UE after the UE transitions to an active state after receipt of the signaling and after subsequently transitioning to the active state, where one or more communications with the UE are based at least in part on the first RNTI.

Aspect 39: The method of aspect 38, further comprising: transmitting timing information that indicates a time for the UE to apply the first RNTI value, wherein communicating with the UE using the first RNTI value is in accordance with the indicated time.

Aspect 40: The method of aspect 39, wherein the indicated time to apply the first RNTI value is with respect to a timing of the transition to the active state or a timing of transmission of associated feedback that corresponds with the signaling, the indicated time is indicated in terms of a quantity of symbols, a quantity of slots, a quantity of time, or any combination thereof.

Aspect 41: The method of any of aspects 38 through 40, further comprising: transmitting, via the signaling, an indication of one or more CCs associated with the first RNTI value, wherein communicating in accordance with the first RNTI value is based at least in part on communicating via a CC of the one or more indicated CCs.

Aspect 42: A UE for wireless communications, comprising a processing system that includes processor circuitry and memory circuitry that stores code, the processing system configured to cause the UE to perform a method of any of aspects 1 through 9.

Aspect 43: A UE for wireless communications, comprising at least one means for performing a method of any of aspects 1 through 9.

Aspect 44: A non-transitory computer-readable medium storing code for wireless communications, the code comprising instructions executable by one or more processors to perform a method of any of aspects 1 through 9.

Aspect 45: A UE for wireless communications, comprising a processing system that includes processor circuitry and memory circuitry that stores code, the processing system configured to cause the UE to perform a method of any of aspects 10 through 19.

Aspect 46: A UE for wireless communications, comprising at least one means for performing a method of any of aspects 10 through 19.

Aspect 47: A non-transitory computer-readable medium storing code for wireless communications, the code comprising instructions executable by one or more processors to perform a method of any of aspects 10 through 19.

Aspect 48: A UE for wireless communications, comprising a processing system that includes processor circuitry and memory circuitry that stores code, the processing system configured to cause the UE to perform a method of any of aspects 20 through 23.

Aspect 49: A UE for wireless communications, comprising at least one means for performing a method of any of aspects 20 through 23.

Aspect 50: A non-transitory computer-readable medium storing code for wireless communications, the code comprising instructions executable by one or more processors to perform a method of any of aspects 20 through 23.

Aspect 51: A network entity for wireless communications, comprising a processing system that includes processor circuitry and memory circuitry that stores code, the processing system configured to cause the network entity to perform a method of any of aspects 24 through 30.

Aspect 52: A network entity for wireless communications, comprising at least one means for performing a method of any of aspects 24 through 30.

Aspect 53: A non-transitory computer-readable medium storing code for wireless communications, the code comprising instructions executable by one or more processors to perform a method of any of aspects 24 through 30.

Aspect 54: A network entity for wireless communications, comprising a processing system that includes processor circuitry and memory circuitry that stores code, the processing system configured to cause the network entity to perform a method of any of aspects 31 through 37.

Aspect 55: A network entity for wireless communications, comprising at least one means for performing a method of any of aspects 31 through 37.

Aspect 56: A non-transitory computer-readable medium storing code for wireless communications, the code comprising instructions executable by one or more processors to perform a method of any of aspects 31 through 37.

Aspect 57: A network entity for wireless communications, comprising a processing system that includes processor circuitry and memory circuitry that stores code, the processing system configured to cause the network entity to perform a method of any of aspects 38 through 41.

Aspect 58: A network entity for wireless communications, comprising at least one means for performing a method of any of aspects 38 through 41.

Aspect 59: A non-transitory computer-readable medium storing code for wireless communications, the code comprising instructions executable by one or more processors to perform a method of any of aspects 38 through 41.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling comprising an indication of a first radio network temporary identifier (RNTI) value, wherein receipt of the control signaling occurs while the UE is in a first radio resource control (RRC) connected state;
transition to an idle state or an inactive state after receipt of the control signaling; and
communicate with a network entity after being in the idle state or the inactive state, wherein one or more communications with the network entity are based at least in part on the first RNTI value.

2. The UE of claim 1, the control signaling comprises a release message, and wherein the control signaling indicates that the UE is to transition to the idle state or to the inactive state.

3. The UE of claim 1, the control signaling is further indicative of one or more timers which indicate a duration of time during which the UE is permitted to use the first RNTI value, and wherein communicating with the network entity based at least in part on the first RNTI value after the UE is in the idle state or the inactive state is further based on satisfaction of the one or more timers.

4. The UE of claim 1, wherein the processing system is further configured to cause the UE to:
communicate in accordance with the first RNTI value while the UE is in the first RRC connected state, wherein the control signaling is further indicative of a permission for the UE to communicate in accordance with the first RNTI value after the UE transitions from the first RRC connected state.

5. The UE of claim 1, the control signaling is further indicative of one or more cells for communication,
communicating with the network entity based at least in part on the first RNTI value includes communicating with a cell of the one or more indicated cells for communication.

6. The UE of claim 1, the control signaling is received from a first cell associated with a first physical cell identifier, and wherein communicating with the network entity based at least in part on the first RNTI value is based at least in part on the network entity being associated with the first physical cell identifier.

7. The UE of claim 1, wherein the control signaling is further indicative of one or more resource sets associated with a random access procedure, and the processing system is further configured to cause the UE to:
perform a first portion of the random access procedure in accordance with the one or more resource sets, the first portion of the random access procedure including a first message transmission and a second message reception, wherein the second message is indicative that the UE is to perform a second portion of the random access procedure, is indicative of one or more additional RNTI values different from the first RNTI value, or both.

8. The UE of claim 7, the first RNTI value is one of a plurality of RNTI values indicated by the control signaling, and wherein the second message indicates whether the UE is to proceed or refrain from proceeding with the second portion of the random access procedure, that the UE is to use the first RNTI value in the one or more communications with the network entity, or both.

9. A user equipment (UE), comprising:
a processing system that includes processor circuitry and memory circuitry that stores code, the processing system configured to cause the UE to:
generate a first plurality of radio network temporary identifier (RNTI) values based at least in part on an initial RNTI value and a pseudo-random sequence, wherein a pseudo-random sequence generator generates the first plurality of RNTI values in accordance with the pseudo-random sequence as a function of time and a first initialization seed value;
communicate in accordance with a first RNTI value of the first plurality of RNTI values at a first instance of time based at least in part on the pseudo-random sequence generator; and
communicate in accordance with one or more second RNTI values of the first plurality of RNTI values at corresponding one or more second instances of time based at least in part on the pseudo-random sequence generator.

10. The UE of claim 9, wherein the processing system is further configured to cause the UE to:
receive initialization information that is indicative of the first initialization seed value for the pseudo-random sequence generator.

11. The UE of claim 9, wherein individual ones of the first instance of time and the one or more second instances of time are separated by a duration, the duration comprising a quantity of slots, a subframe, a radio frame, or any combination thereof.

12. The UE of claim 9, wherein the processing system is further configured to cause the UE to:
reset a current value of the first initialization seed value to an initial value of the first initialization seed value; and
generate one or more second pluralities of RNTI values based at least in part on an updated initial RNTI value and an additional pseudo-random sequence, wherein the pseudo-random sequence generator generates the one or more second pluralities of RNTI values based at least in part on the additional pseudo-random sequence in accordance with the function of time and the reset initial value of the first initialization seed value, and wherein each of the first initialization seed value and the reset initial value of the first initialization seed value are applied at corresponding initialization times.

13. The UE of claim 12, the corresponding initialization times are each separated by a first duration,
the first duration comprises a quantity of radio frames, is in accordance with a system frame number, or both, and wherein the first duration is greater than or equal to a second duration that separates individual ones of the first instance of time and the one or more second instances of time.

14. The UE of claim 13, wherein the processing system is further configured to cause the UE to:
receive control signaling indicating the first duration, the second duration, or both.

15. The UE of claim 9, wherein the processing system is further configured to cause the UE to:
transmit capability information indicating an ability of the UE to operate in accordance with the first plurality of RNTI values based at least in part on the pseudo-random sequence generator; and
receive control signaling comprising an indication to operate in accordance with the first plurality of RNTI values based at least in part on the pseudo-random sequence generator, wherein the control signaling is based at least in part on the capability information.

16. The UE of claim 9, wherein the processing system is further configured to cause the UE to:
receive control signaling indicating a first set of allowable RNTI values permitted for communication, wherein the first plurality of RNTI values is in accordance with the first set of allowable RNTI values, wherein the first set of allowable RNTI values is associated with the UE and is different from a second set of allowable RNTI values associated with one or more additional UEs.

17. The UE of claim 9, wherein the processing system is further configured to cause the UE to:
receive control signaling that indicates a type of the first plurality of RNTI values for which the pseudo-random sequence generator is to be used, wherein the type is one of a cell RNTI (C-RNTI), a configured scheduling RNTI (CS-RNTI), a modulation and coding scheme C-RNTI (MCS-C-RNTI), a slot format indication RNTI (SFI-RNTI), a transmit power control for physical uplink shared channel RNTI (TPC PUSCH-RNTI), a transmit power control for physical uplink control channel RNTI (TPC PUCCH-RNTI), or a transmit power control sounding reference signal RNTI (TPC SRS-RNTI).

18. A user equipment (UE), comprising:
a processing system that includes processor circuitry and memory circuitry that stores code, the processing system configured to cause the UE to:
receive signaling that comprises an indication of a first radio network temporary identifier (RNTI) value, wherein receipt of the signaling occurs while the UE is in a radio resource control (RRC) idle state or an RRC inactive state, and wherein the signaling comprises a paging message;
transition to an active state after receipt of the signaling; and
communicate with a network entity after transitioning to the active state, where one or more communications with the network entity are based at least in part on the first RNTI.

19. The UE of claim 18, wherein the processing system is further configured to cause the UE to:
receive timing information that indicates a time for the UE to apply the first RNTI value, wherein communicating with the network entity using the first RNTI value is in accordance with the indicated time, wherein the indicated time to apply the first RNTI value is with respect to a timing of the transition to the active state or a timing of transmission of associated feedback that corresponds with the signaling, and wherein the indicated time is indicated in terms of a quantity of symbols, a quantity of slots, a quantity of time, or any combination thereof.

20. The UE of claim 18, wherein the processing system is further configured to cause the UE to:
receive, via the signaling, an indication of one or more component carriers associated with the first RNTI value, wherein communicating in accordance with the first RNTI value is based at least in part on communicating via a component carrier of the one or more indicated component carriers.
